(19) United States
(12) Patent Application Publication
(10) Pub. No.: US 2002/0082879 A1
(43) Pub. Date: Jun. 27, 2002

(54) Method and system for seat selection and ticket purchasing in a networked computer system

(76) Inventors: Brent Miller, San Diego, CA (US); Steve Souza, San Deigo, CA (US); Jonathon Seigle, Santa Ana, CA (US)

Correspondence Address: KENYON S. JENCKES, Fish & Richardson P.C., Suite 500, 4350 La Jolla Village Drive, San Diego, CA, 92122, US

(21) Appl. No.: 09/750,445

(22) Filed: Dec. 27, 2000

Related U.S. Application Data
(60) Provisional application No. 60/229,834, filed on Aug. 31, 2000.

(51) Int. Cl. G06F 17/60

(52) U.S. Cl. 705/5

(57) ABSTRACT

A system provides potential patrons of a venue with information about seats in the venue over the Internet. Users of the system may select seat objects from an interactive seat map and receive information about the seat. The seat information may include photographic images of the seat or its view or textual comments about the seat. Each seat object in the seat map may be pointer-sensitive and linked to an entry in a database relating to a corresponding seat. A Method is provided for pricing seats in a seat map. A number of seats in a venue may be selected and assigned a ticket price for an event. Seats with different prices may be designated with different colors on the seat map when pricing the seats.

### COPYRIGHT NOTICE PURSUANT TO 37 C.F.R. 1.71(E)

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A ticket purchaser may consider the quality of the view from a seat and comfort of the seat in a venue to be important criteria when purchasing a ticket for an event with assigned seating, for example, a concert or a play.

Section level maps and seat level maps representative of seating arrangements in a venue may be helpful in determining the quality of the view from a seat. Such maps may be provided on an Internet site for ease of access by the ticket purchaser. However, it may be desirable to provide more detailed information about a particular desired seat from the Internet site.

### SUMMARY

A system according to an embodiment provides potential patrons of a venue with information about seats in the venue over the Internet. Users of the system may select seat objects from an interactive seat map and receive information about the seat. The seat information may include photographic images of the seat or its view or textual comments about the seat. Each seat object in the seat map may be pointer-sensitive and linked to an entry in a database relating to a corresponding seat.

A Method according to an embodiment is provided for pricing seats in a seat map. A number of seats in a venue may be selected and assigned a ticket price for an event. Seats with different prices may be designated with different colors on the seat map when pricing the seats.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a system for providing interactive section level maps and seat level maps for venues available to users through an Internet site.

FIG. 2 is a section level map according to an embodiment.

FIG. 3 is a seat level map according to an embodiment.

FIG. 4 is a flow diagram for venue processing operation according to an embodiment.

FIG. 5 is a flow diagram for a section level mapping operation according to the embodiment of FIG. 4.

FIG. 6. is a dialog box for defining the scale of a map according to an embodiment.

FIG. 7 is a dialog box for entering information about a section map according to an embodiment.

FIG. 8 is a flow diagram for a section finding operation according to the embodiment of FIG. 4.

FIG. 9 is illustration of an exemplary section contour according to an embodiment.

FIG. 10 is a flow diagram for a section mapping operation according to the embodiment of FIG. 4.

FIGS. 11A-11F are search tables for an edge follower operation in a northern direction of travel according to an embodiment.

FIGS. 12A-12F are search tables for an edge follower operation in a southern direction of travel according to an embodiment.

FIGS. 13A-13C is a flow diagram for a corner search operation according to the embodiment of FIG. 4.

FIG. 14 is a continuation of the flow diagram of FIGS. 13A-13C.

FIG. 15A-15B is a flow diagram for a seat level mapping operation according to the embodiment of FIG. 4.

FIG. 16 is a dialog box for entering information about a seat map according to an embodiment.

FIG. 17 is a flow diagram for a row finding operation according to the embodiment of FIG. 4.

FIG. 18 continues the flow diagram of FIG. 17.

FIG. 19 is an illustration of an exemplary row of seat objects according to an embodiment.

FIG. 20 is an illustration of another exemplary row of seat objects according to an embodiment.

FIGS. 21A-21B is a flow diagram for a seat finding operation according to the embodiment of FIG. 4.

FIG. 22 is a display screen for an interactive section level map according to an embodiment.

FIG. 23 is a display screen for an interactive seat level map according to an embodiment.

FIG. 24 is a display screen including a textual review of a seat according to an embodiment.

FIG. 25 is a display screen including a view photograph according to an embodiment.

FIG. 26 is a display screen including a seat photograph according to an embodiment.

FIG. 27 is a display screen including comments regarding a seat according to an embodiment.

FIG. 28 is an interactive map for a restaurant according to an embodiment.

FIGS. 29A and 29B are a flow diagram of a seat selection operation according to an embodiment.

FIG. 30 is a flow diagram of a ticket purchasing operation according to an embodiment.

FIG. 31 is a flow diagram of a seat reservation operation according to alternate embodiments.

FIGS. 32A and 32B are a flow diagram of a seat pricing operation according to an embodiment.

FIG. 33 is a display screen for input of event/performer information.

FIG. 34 is a display screen for input of event time(s) and day(s).

FIG. 35 is a display screen for input of event date(s) and time(s).

FIG. 36 is a display screen including a section map for pricing seats according to an embodiment.

FIG. 37 is a display screen including a seat map for pricing seats according to an embodiment.

FIG. 38 is a confirmation screen according to an embodiment.

FIG. 39 is a display screen for input of textual description of an event.

FIG. 40 is a submission screen according to an embodiment.

FIG. 41 is a display screen for requesting a sales report according to an embodiment.

FIG. 42 is a display screen including a display screen according to an embodiment.

FIG. 43 is a table for entering a tiered pricing structure for different buyer and discount types.

Like reference symbols in the various drawings indicate like elements.

### DETAILED DESCRIPTION

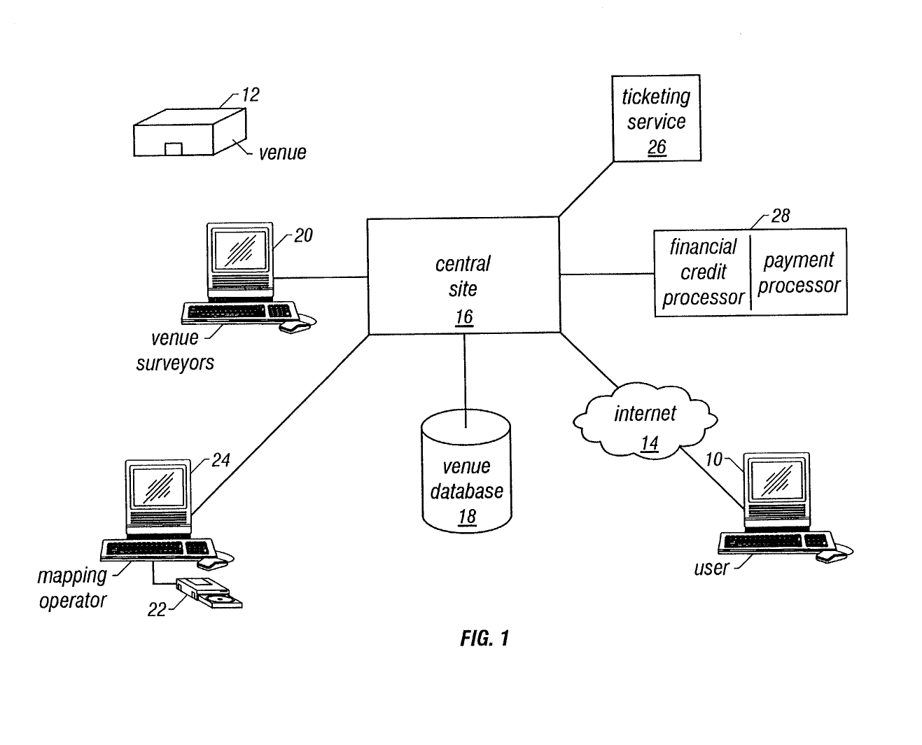

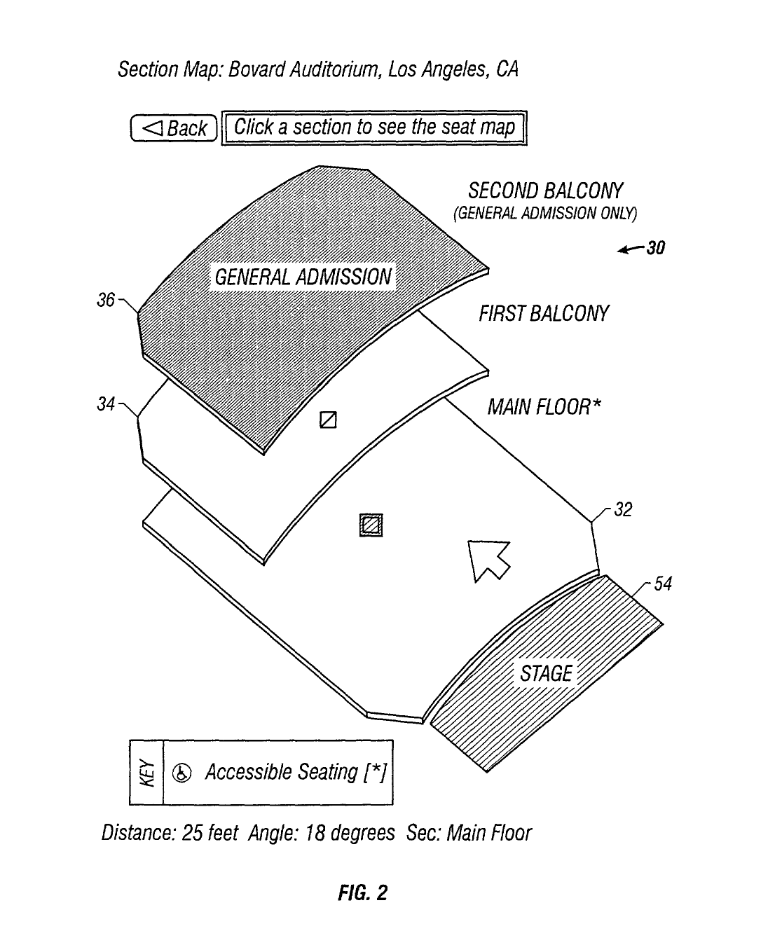

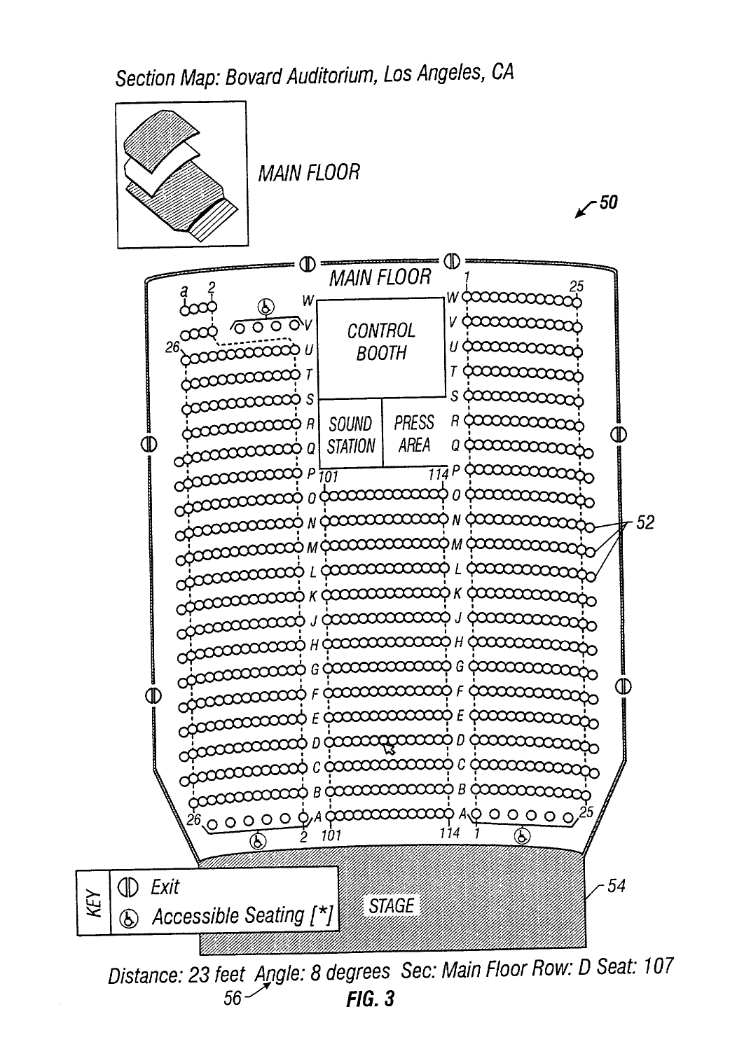

FIG. 1 illustrates a system according to an embodiment for enabling a remote user 10 to access interactive maps associated with a venue 12 over a network connection 14, e.g. a World Wide Web site on the Internet. Some venues (e.g., large stadiums) may have only section level maps and seat information pages in lieu of seat level maps. Each venue 12 may have a number of seats arranged in one or more sections and may have an associated interactive section level map(s) 30, as shown in FIG. 2, and/or seat level map(s) 50 as shown in FIG. 3, representing actual sections and seats in the venue 12.

Section objects and seat objects in raw image files of the section level and seat level maps may be mapped and made pointer-sensitive. These objects may be transformed into “hotspots” on the displayed image that activate a function when selected. Information from an object mapping operation may be compiled into text files and transmitted to a central site 16 and imported into the venue database 18.

According to an embodiment, an Internet site is provided that enables a user to purchase and/or reserve a ticket for a seat in a venue directly from the interactive seat level map 50. The interactive seat level map 50 includes seat icons 52 that represent the actual arrangement of seats in the venue 12. By selecting a seat icon 52 in the seat level map 50 with a pointing device, the user may be provided information regarding a particular seat that includes, for example, the distance of the seat from the stage 54, a viewing angle 56 to the stage from the seat, an image representative of the actual view from the seat, an image representative of the actual seat, ratings and/or reviews of the view and sound quality from the seat and the comfort of the seat. In addition, the user may purchase a ticket for that seat directly from the Internet site.

According to an embodiment, an operation is provided to automatically compute the pixel region associated with each section icon 32 (FIG. 2) or seat icon 52 in an associated section level map or seat level map, respectively.

Information regarding the section and seat to be entered into the database may be obtained by venue surveyors at the venue 12. Information relating to the accuracy of the graphical image files from which the interactive maps are created may also be acquired at the venue 12. This information may include, for example, distances between rows, aisles, and sections, distances between the seats and a focal point of the stage, the height of elevated sections, the convention used to identify rows, aisles, and sections, the locations of obstructions, exits, and designated seats and access ramps for the disabled.

The focal point of the stage may be any “point of interest” in the venue as defined by the surveyor. For example, this may be center stage or a point at the center of the front edge of the stage.

Examples of conventions used to identify seats and/or sections and rows include, for example, alphabetic (A→B, AA→BB), numeric (1→2), or a combination of both (A1→A2).

Other information that may be associated with particular seats in the database include photographs and textual descriptions. A photograph of each seat, or a seat representative of those in a particular group of seats, may be taken and converted to a digital image stored in the database. A photograph of an actual view from each seat, or a seat having a view representative of a particular group of seats, may be taken and converted to a digital image stored in the database. An object may be placed on the stage, for example, a life-size cut-out of a human figure, to provide a better perspective of the viewing distance and angle from a particular seat. The visit to the venue may provide a basis for textual descriptions and reviews of particular seats to be entered into the venue database 18.

Some venues may have different seating arrangements for different events. For example, a venue that hosts concerts, plays, sporting events, and special functions may have different seating arrangements for each type of event. Information for creating appropriate section level maps and seat level maps may all be obtained at the visit to the venue.

The venue surveyors may import the venue information into the venue database 18 remotely from a venue surveyor machine 20. The venue surveyor machine 20 may be a general purpose computer in communication with the central site 16 through a network connection. The venue surveyor may also enter reviews of the particular section or seats provided by other patrons who have seen an event from a particular seat.

Each venue may have had an associated section level map 30, (FIG. 2), and/or one or more associated seat level map 50, (FIG. 3). A particular venue may have more of each type of map depending on the number of sections and seating arrangements compiled for that venue. The section level and seat level maps may be in a digital graphical image file, for example, a GIF or JPEG format, or other known or currently unknown but contemplated future file formats for graphical images. Each map is drawn roughly to scale and may be of varying detail.

A mapping operator performs mapping operations on the raw image files of the section level and seat level maps according to various embodiments described below. The instructions for performing the mapping operation may reside in a memory or machine readable medium, e.g., a CD-ROM 22 residing in a mapping machine 24.

The mapping machine 24 may be a general purpose computer in connection with the central site 16 through a network connection. The instructions for performing the mapping operations may be in the JAVA programming language. JAVA is an object oriented language that is advantageously platform-independent and may run on any machine utilizing a JAVA Virtual Machine. However, the instructions may be implemented in hardware and/or in software using a number of different interpreters or compilers and programming languages.

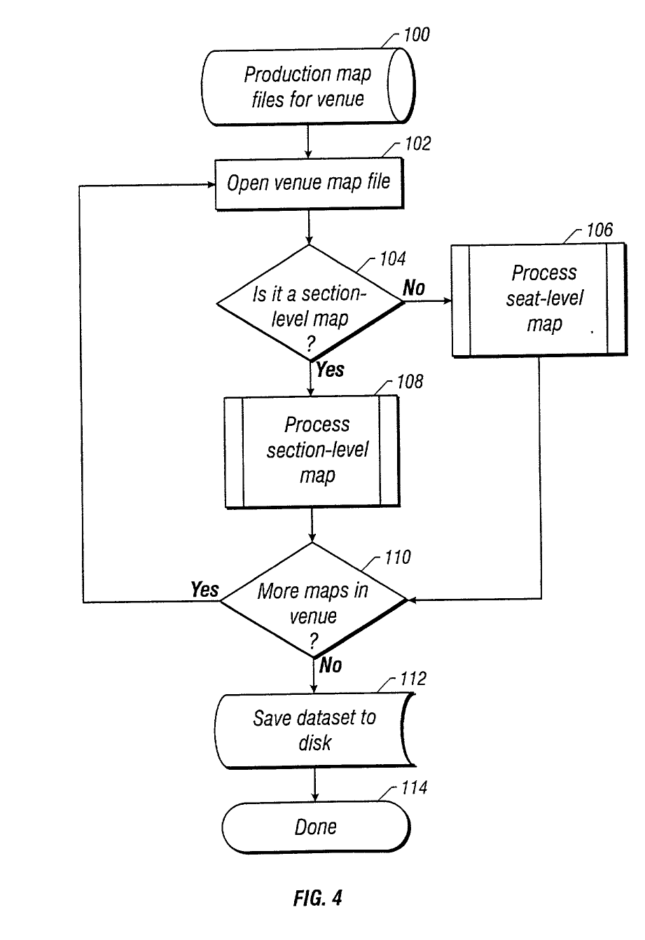

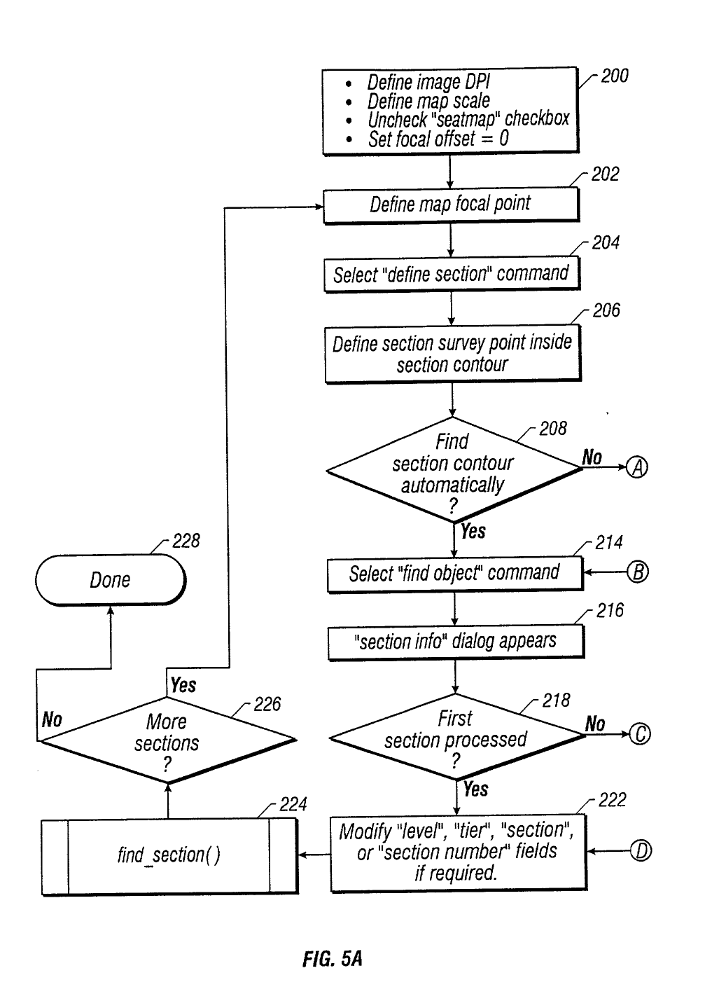

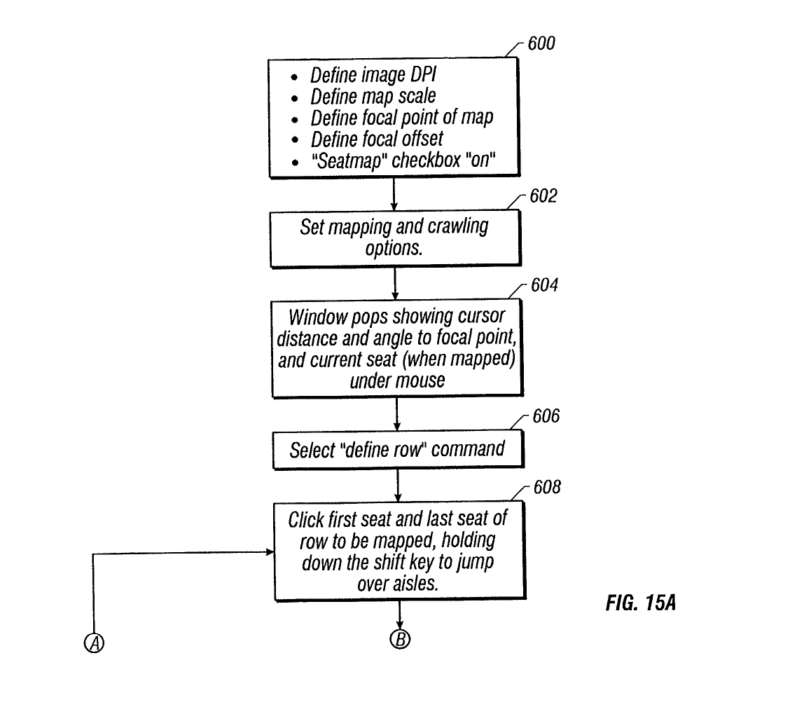

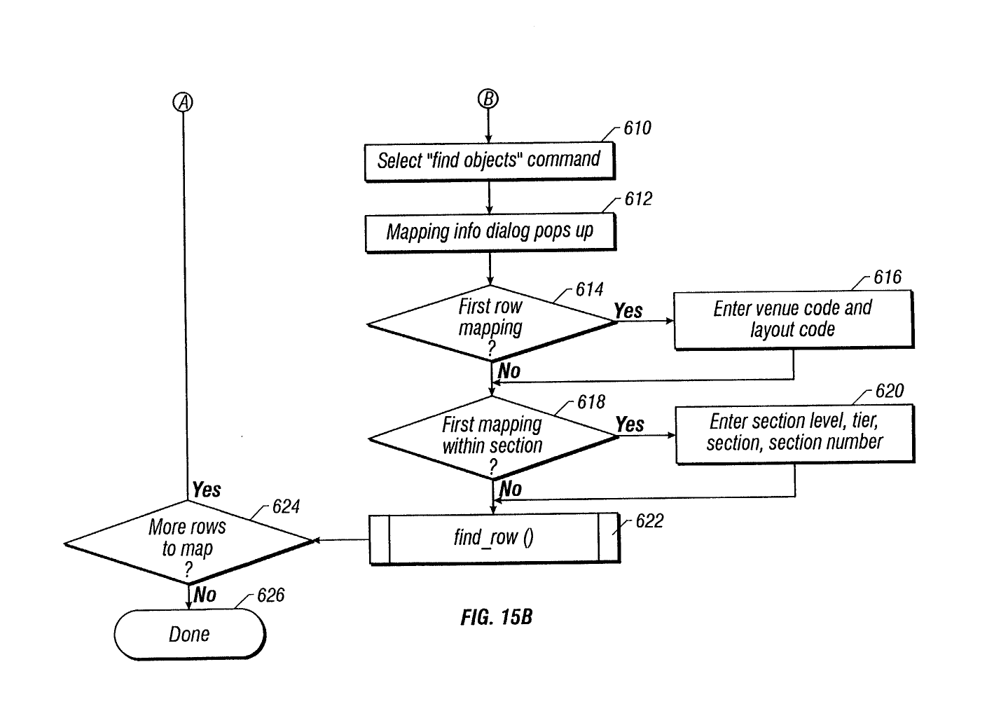

FIG. 4 illustrates the flow of a map processing operation for a venue according to an embodiment. The production map files, i.e., the raw graphical image files, for a venue are stored in a venue file in state 100. A venue map file for the venue is opened in state 102. Maps determined to be section level maps in state 104 are processed in state 108 using a mapping operation described below in connection with FIGS. 5 to 14. Maps determined to be seat level maps in state 104 are processed in state 106 using a mapping operation described below in connection with FIGS. 15 to 21. When it is determined in state 110 that all maps for the venue have been processed, the processed maps in the dataset corresponding to the venue may be saved to disk in state 112 for subsequent import to database or directly upload to a database on a server on a network, at which point the operation may be terminated in state 114.

Returning to FIG. 2, the section level map 30 illustrates a general outline, or contour, of the various sections 32, 34, 36 and their relation to a stage 54. Each section that includes assigned seating, e.g., “First Balcony” 34 and “Main Floor” 32, may be pointer-sensitive.

The operator may use the section mapping operations according to an embodiment described in connection with FIG. 5 to compute the coordinates of the pixels that lie inside a section contour. Once these pixels are determined, they may be made pointer-sensitive and associated with information regarding that particular section in the venue database 18.

In the original image file for the section level map, each section icon may be represented as a blank region including white, “off”, pixels defined by a boundary line having black, “on”, pixels. Generally, the section mapping operation begins with the operator selecting a point inside a particular section, from which the operation travels in a defined or default direction until it encounters an “on” pixel in the boundary line. The operation then travels along other “on” pixels in the border line until all pixels on a contour, e.g., an inner contour, of this border line is determined. From these points, corner points are chosen which define a polygon that approximates the shape of the section object. All pixels in an area defined by that polygon are made pointer-sensitive and associated with information relating to the particular section in the database.

It may not be necessary or desirable to achieve a perfect fit between the polygon and the border line. Accordingly, the polygon may be a rough approximation generated automatically by the mapping operation or defined manually by operator-selected corner points. Approximating the polygon to the borderline may advantageously conserve storage space by limiting the number of points that must be stored to define the contour. This may be significant for section contours having curved borders and/or complex geometries.

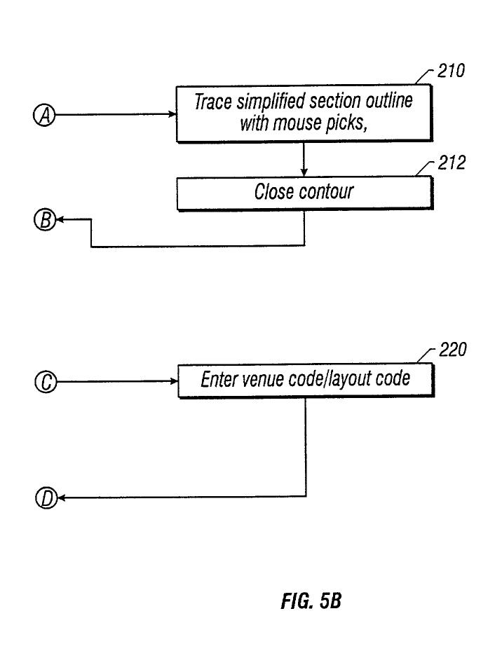

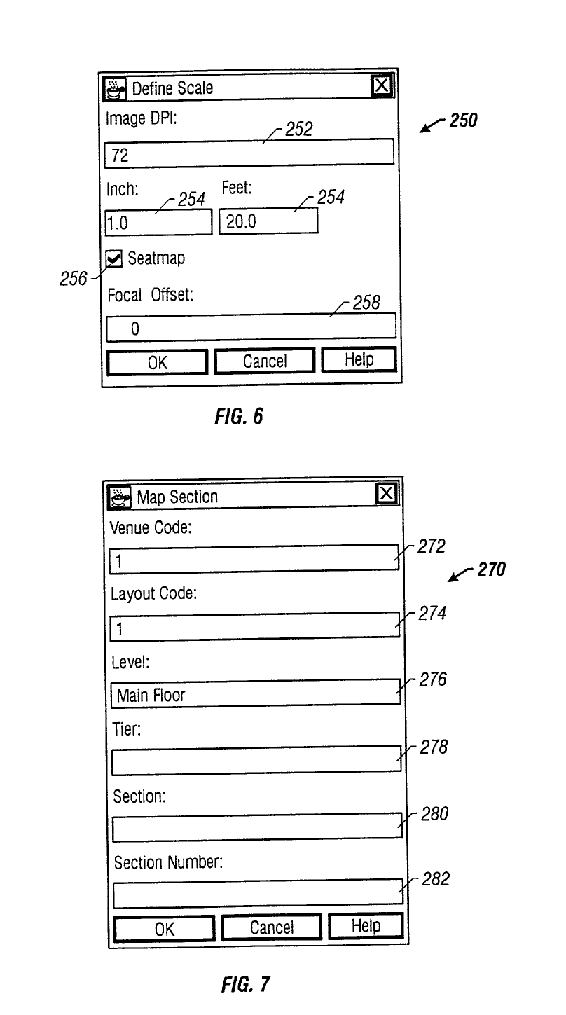

When a raw graphical image file is selected from the venue file for mapping, a “define scale” dialog box 250, such as that shown in FIG. 6, may be displayed. As shown in FIG. 5, the operator may be prompted to define an image dots per inch (“DPI”) value in field 252, a map scale value in field 254, deselect the “seat map” check box 256, and set a focal offset value to “0” in field 258 in state 200. An exemplary DPI value for a GIF image file according to an embodiment is seventy-two (72).

The operator may define the focal point of the map with a pointer device in state 202. As described above, the focal point may be a point at or near center stage or a point at or near the center of the front edge of the stage. The focal point may be different for different events. For example, the focal point may be any point of interest in a venue and may lie on the 50-yard line for a football layout, half-court for a basketball layout, or home plate for a baseball layout.

When the operator selects a “define section” command in state 204, the operator may designate a section survey point inside the selected section contour, e.g., Main Floor 32, using the pointer device. If the operator decides to define the designated section manually in state 208, the operator may trace a simplified section outline on or around the section contour in the image file with pointer picks in state 210 and close the contour in state 212.

When the operator selects a “find object” command in state 214, the operator may be prompted to provide information related to that particular section in a “map section” dialog box 270, as shown in FIG. 7. The “map section” dialog box 270 has data entry fields that may include, for example, venue code 272, layout code 274, level 276, tier 278, section 280, and section number 282.

The layout code corresponds to a particular type of seating arrangement typical to a type of performance, for example, a theater, play, or concert layout.

The venue code uniquely identifies a venue. The venue code is the same for every layout of a venue.

The level, tier, section, and section number may all be alphanumeric strings corresponding to a label identifying the respective seating area.

According to the present embodiment, at least the layout code and venue code are filled in for the first section in state 220. For subsequent sections, the level, tier, section, and section number fields may be modified in state 222 if appropriate.

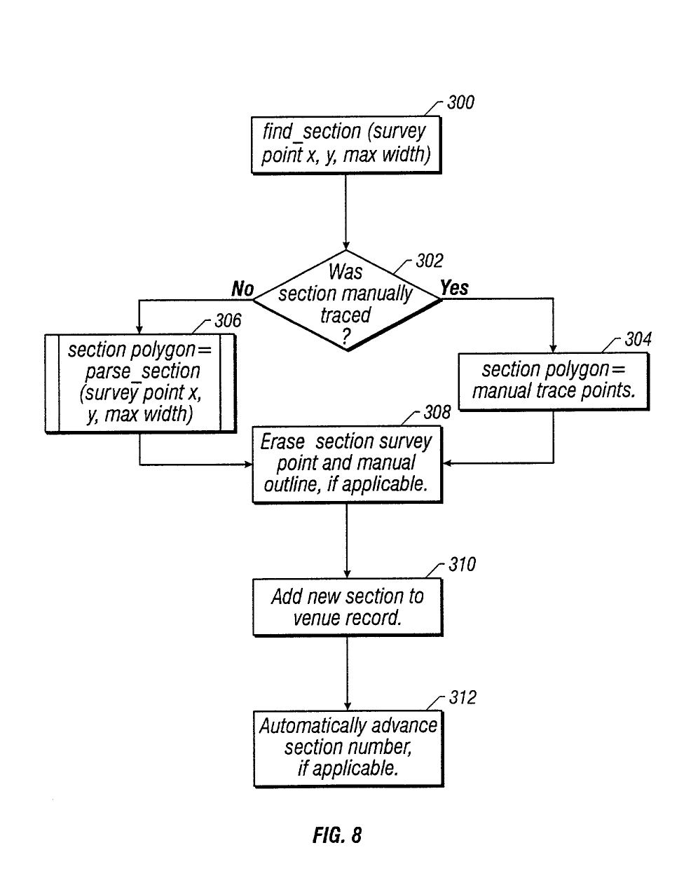

After identifying the section, a section finding operation, described below in connection with FIG. 8, may be carried out in state 224 to define a section polygon corresponding to the section contour in the image file. If more sections are determined to remain in the venue in state 226, the operation may return to state 202. Otherwise, the section finding operation may terminate in state 228.

As shown in FIG. 8, the section finding operation passes in the x, y coordinates of a survey point and a defined or default maximum width value at state 300. If the section contour is determined to be manually traced in state 302, the polygon may be defined by the manually entered trace points in state 304. Otherwise a section mapping operation may be initiated in state 306 to determine a number of corner points that define the polygon. An embodiment of the section mapping operation is described below in connection with FIGS. 8-14.

When the polygon is defined, extraneous points such as the section survey point and manual outline may be erased in state 308. The mapped section object defined by the polygon may be added to the venue record in state 310. The section number may be automatically advanced for a subsequent section finding operation in state 312.

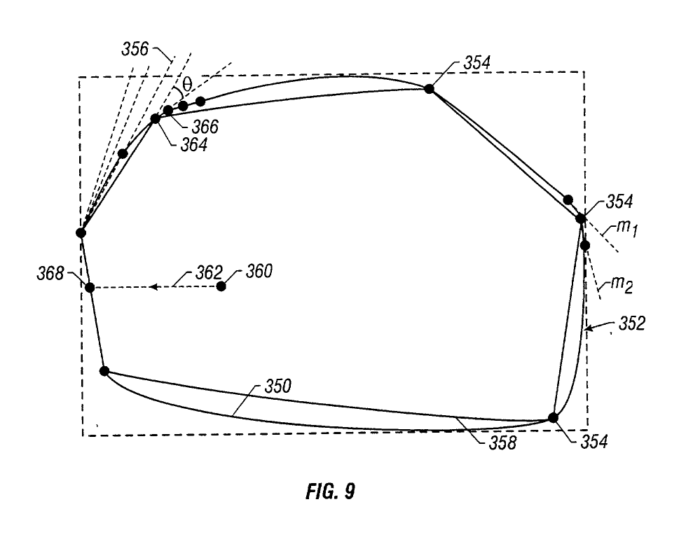

As shown in FIG. 9, the automatic section mapping operation according to an embodiment generally follows an inside contour 350 of a section object 352 and identifies a number of corner points 354 determined by their degree of deviation from a line or line-like segment 356 being traced between successive points. These corners 354 may be used to define a section polygon 358 approximating the section object 352 in the raw image file.

To initiate the section mapping, the operator may select a section survey point 360 by clicking on or otherwise selecting a pixel within the contour of the unmapped section object 352. From the survey point 360, pixels may be scanned in a defined or default direction 362 until an “on” pixel is encountered.

A pixel may be a considered a corner candidate if subsequent pixels on the border deviate from the line 356 being traced. Several mapping options having defined or default values may be used to determine a significant deviation.

The section mapping operation may be iterative. On a first edge following operation, a raw list of the coordinates of “on” pixels found on the inner contour may be stored in a mapping database. These points may then be evaluated in one or more operations based on mapping criteria to determine those “on” pixels that deviate significantly from the line and store these “on” pixels as corner point candidates. Corner points to be used in the polygon 358 may be determined from these corner point candidates in subsequent operations based on mapping criteria. The mapping criteria may include defined or default mapping options available to the operator.

A maximum deviation option may be used to monitor the number of increasing deviations from an angle φ from the line 356 after which the pixel point 364 preceding the first point-of-deviation 366 is considered a corner point. The maximum deviation option may be used to detect corner points in a raw list of section outline points obtained in a first iteration of the edge following operation. An exemplary default value is three (3) deviations.

A slope tolerance option may be used to monitor a percentage change between a slope m1 and a slope m2 at which two points are considered to be on different lines. The slope tolerance option may be used to remove redundant points in a section contour in a later iteration to identify corner points used in the polygon. An exemplary default value is twelve percent (12%).

A line tolerance option may be used to monitor the minimum number of degrees of deviation angle must differ from the current vector in order to be considered a valid deviation.

A collapse point option may be used to set a sampling interval to determine how many pixels apart two points on a section contour must be in order for both to be considered valid corner point candidates. Points less than this number apart may be removed from consideration. This may advantageously reduce the number of points stored in the database for the section polygon.

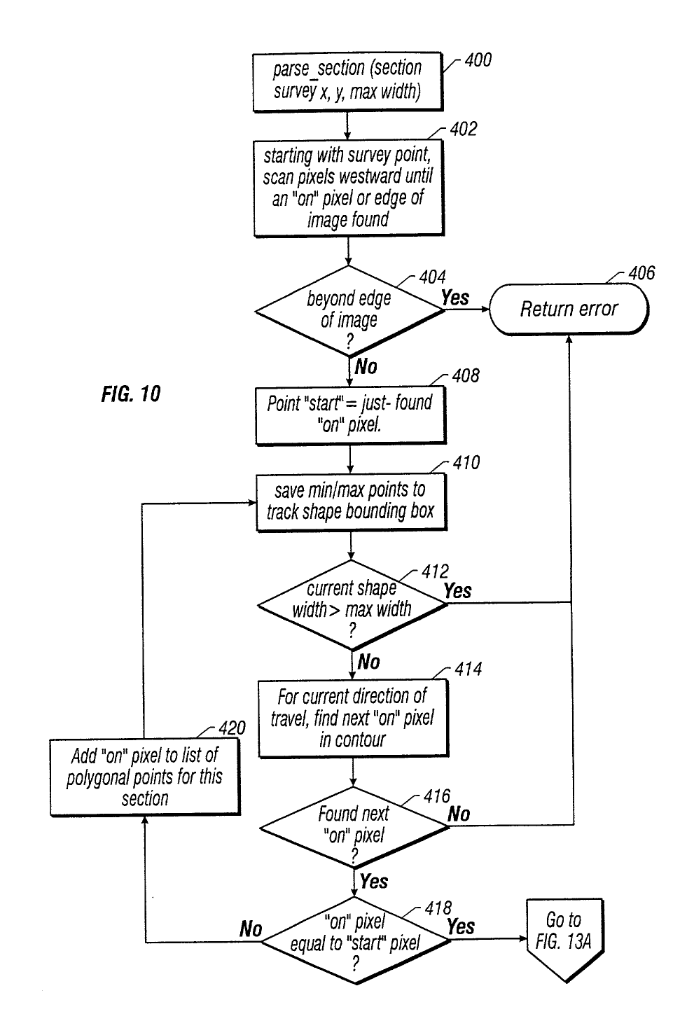

As shown in FIG. 10, the section mapping operation operates on the coordinates of the section survey point and the maximum width value which may be passed into the program at state 400. Starting at the survey point coordinates, pixels may be scanned in a defined or default direction until an “on” pixel, representing an edge of the section contour, is encountered in state 402. An exemplary scan direction 362 (FIG. 9) is westward. If the survey point is determined to be outside of the section object in state 404, an error value may be returned in state 406. Otherwise the coordinates of a start point may be set to the coordinates of the found “on” pixel in state 408.

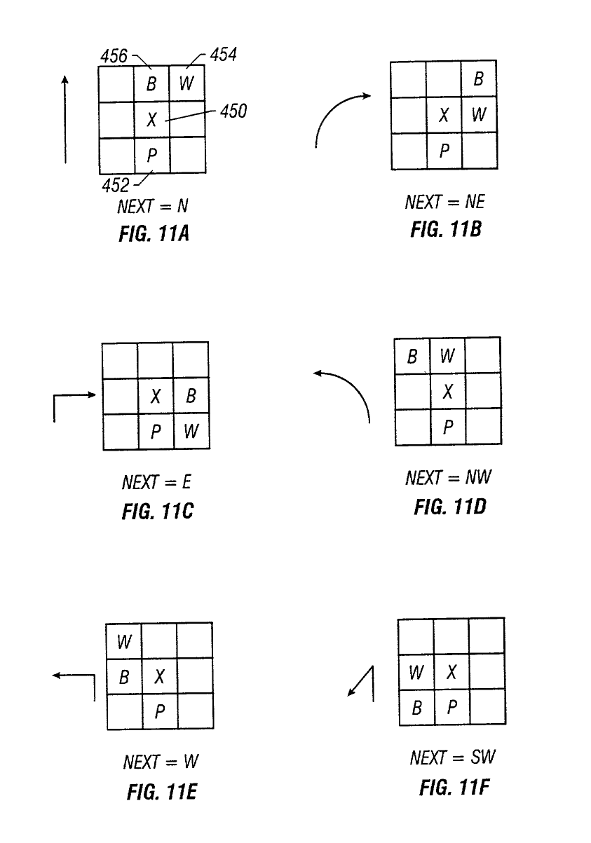

According to an embodiment, all pixels defining the inner contour of the section object 352 are identified using an edge follower operation, examples of which are described in FIGS. 11A-F and 12A-F. The exemplary edge follower may examine pixels adjacent to the current pixel 450 based on a protocol corresponding to a current direction of travel. The current direction of travel may be determined by the orientation of a previous pixel 452 to the current pixel 450, or may be a defined or default direction for the starting pixel. The exemplary search tables shown in FIGS. 11A-11F correspond to a clockwise search of an inner contour in a northern direction of travel.

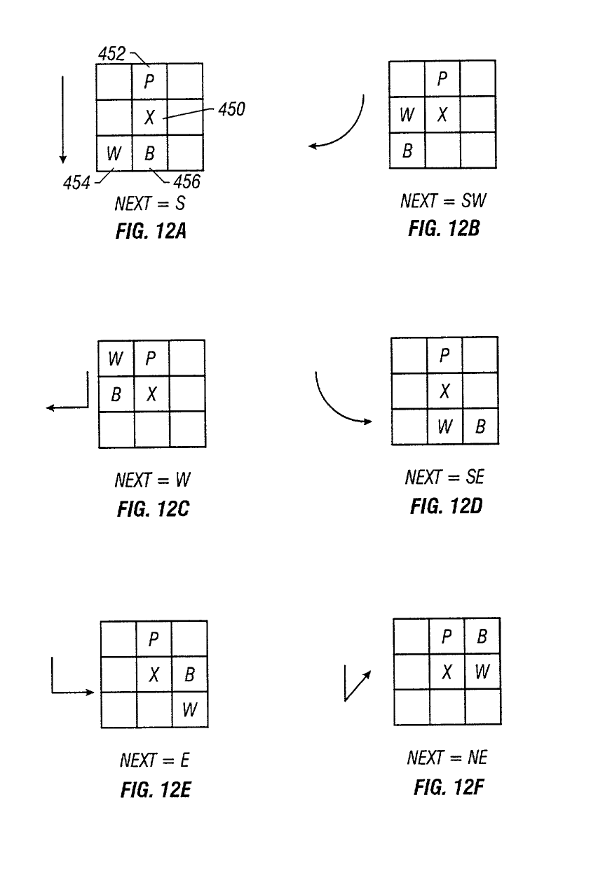

FIGS. 11A-F describe a search table for the northern direction of travel in descending level of priority. That is, FIG. 11A illustrates the first search pixel search operation attempted and FIG. 11F the last. FIGS. 12A-F describe a similar protocol, but for a southern direction of travel in a clockwise search.

Lines that define the contour of an object may be more than one pixel deep. To prevent the edge follower from traveling into the line defining the contour, the edge follower may search for an “off” pixel 454 adjacent to a found “on” pixel 456. This ensures that the edge follower remains on the edge of the contour.

The section object in the image file may be considered a “blob.” Regardless of its shape, the blob may be contained in a bounding box. The bounding box may be a rectangle that contains the blob and is defined by the minimum and maximum x- and y-coordinates of the blob. The bounding box may be used to determine a maximum width of the section object 352 (FIG. 9).

Starting with the coordinates of a start pixel 368, the minimum and maximum x, y values may be stored to track the shape of the bounding box in state 410 (FIG. 10).

If the current shape width is determined to be greater than the maximum width in state 412, an error value may be returned. Otherwise a next “on” pixel in the contour is searched based on the search table for the current direction of travel in state 414.

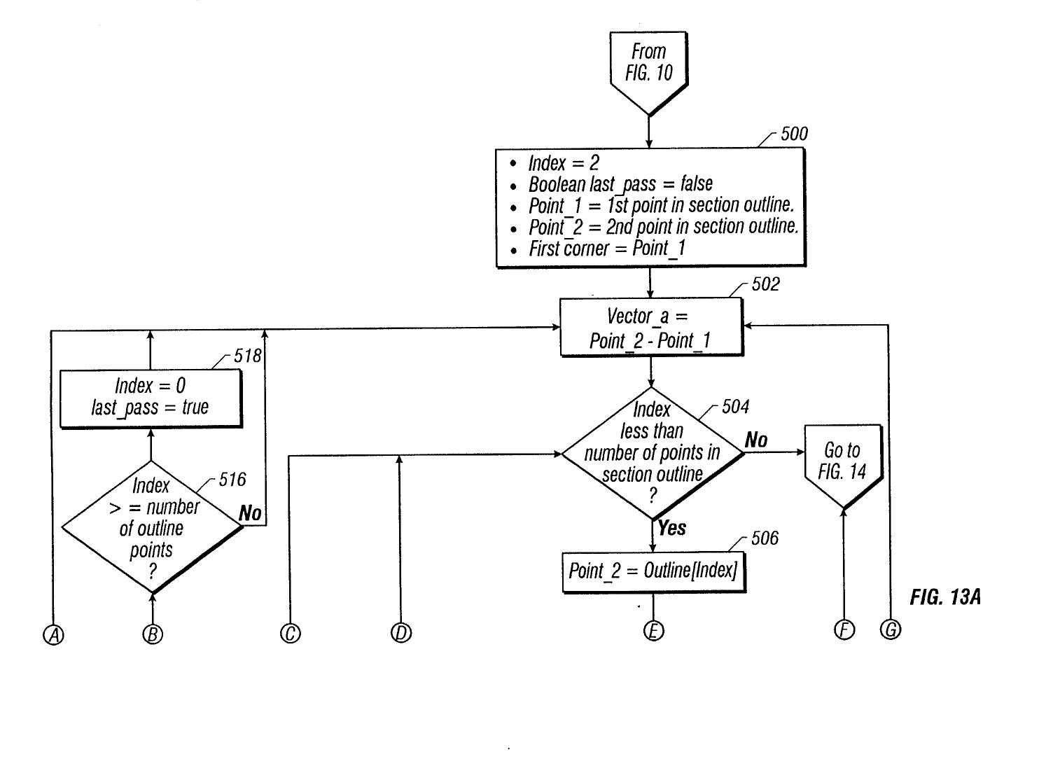

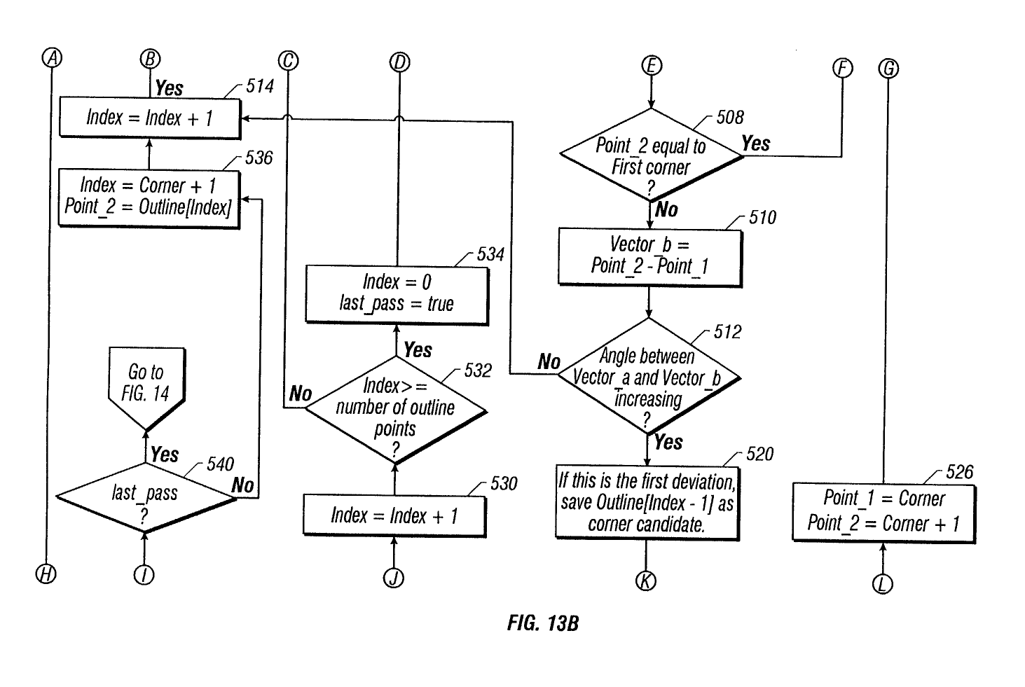

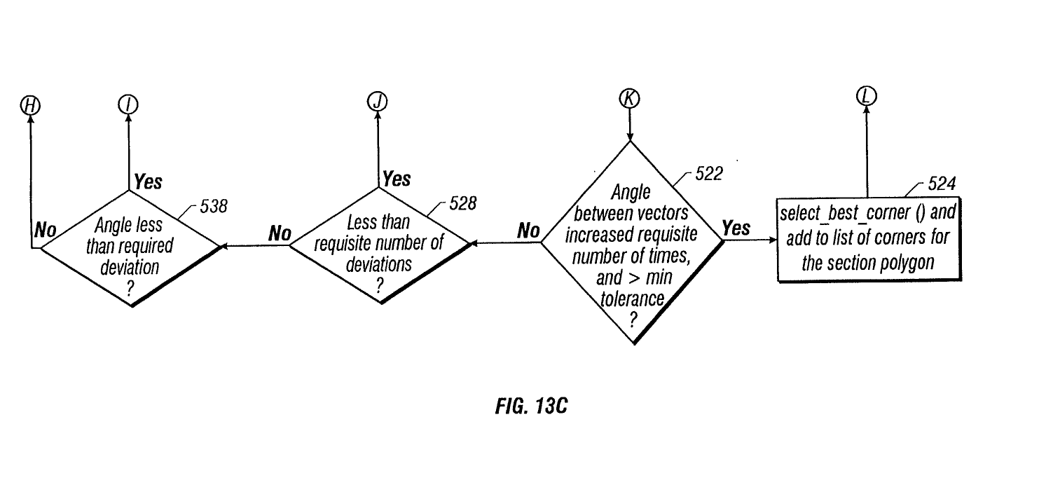

If no next “on” pixel is identified, an error value may be returned. Otherwise the coordinates of the next “on” pixel are compared to the coordinates of the start pixel. If the coordinates are determined to be different in state 420, the operation may return to state 410. Otherwise a corner search operation may be initiated in state 500, as shown in FIGS. 13A-C.

According to the present embodiment, upon initiation of the corner search process, an “Index” value may be set to “2”, a Boolean “last_pass” value is set to FALSE, the coordinates of a “Point_{—}1” set to the coordinates of a first point in the section outline, the coordinates of a “Point_{—}2” set to the coordinates of a second point in the section outline, and the coordinates of a first corner set to the coordinates of “Point_{—}1” in state 500.

A “Vector_a” value may be set to the value of “(Point_{—}2-Point_{—}1)” at state 502.

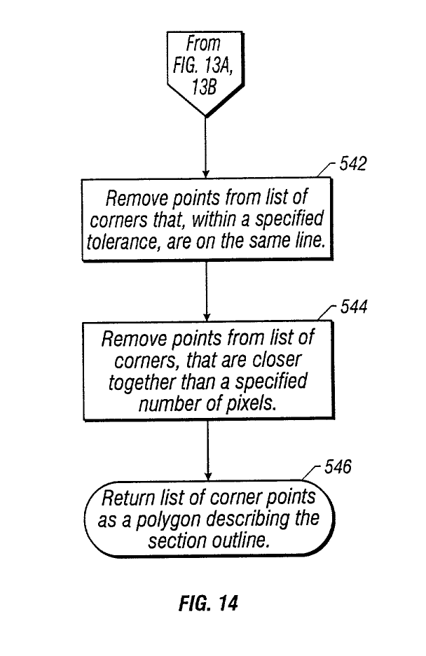

The value of “Index” is inspected in state 504. The state in which “Index” equals the number of points in the section outline corresponds to a completed edge following operation about the inner contour of the section object. If “Index” is determined not be less than the number of points in the section outline in state 504, points from a list of corners that, within a specified tolerance, are not on the same line may be removed from the list in state 542, as shown in FIG. 14. Points for the list that are closer together than a specified number of pixels may also be removed from the list in state 544. The list including corner points 354 may be returned to define the section polygon in state 546. If the “Index” is determined to be less than the number of points in the section outline in state 504, “Point_{—}2” is set to a value “Outline[Index]” in state 506. If “Point_{—}2” is determined to be equal to the stored “first corner”, the operation may return to state 542 (FIG. 14). Otherwise, a “Vector_b” is set to the value “(Point_{—}2-Point_{—}1)” in state 510.

An angle α may be calculated between “Vector_a” and “Vector_b” at each iteration of the corner search operation and stored. If angle α is determined not to be increasing in state 512, “Index” is incremented by “1” in state 514. If “Index” is determined to be greater than or equal to the number of points in the outline in state 516, “Index” may be set to “0” and the value of “last_pass” set to “true” in state 518 and the operation may return to state 502.

If “Index” is determined to be less than the number of outline points, the operation may return to state 502.

If angle α is determined to be increasing at state 512, “Outline[Index−1]” may be saved as a corner candidate at state 520 if it constitutes a first deviation.

If angle α is determined to have increased a requisite number of times and is greater than a minimum tolerance in state 522, “Point_{—}1” may be selected as a corner candidate and added to the list of corner points for the polygon in state 524. “Point_{—}1” may be set to a “Corner” value and “Point_{—}2” set to a “(Corner+1)” value in state 526. The operation may then return to state 502.

If angle α is determined to have not increased the requisite number of times in state 528, “Index” may be set to “(Index+1)” in state 530. If “Index” is determined to be greater than or equal to the number of outline points in state 532, “Index” may be set to “0” and “last_pass” set to “true” in state 534. The operation may then return to state 504.

If “Index” is determined to be less than the number of outline points in state 532, the operation may return to state 504.

If the number of deviations is determined not to be less than the requisite number of deviations in state 528 and angle α is determined not to be less than the required deviation in state 538, then the operation may return to state 502. Otherwise, the value of “last_pass” is inspected in state 540. If “last_pass” is “true”, the operation may return to state 542 (FIG. 14). Otherwise, “Index” is set to a value “(Corner+1)” and “Point_{—}2” set to “Outline[Index]” at state 536. The operation may then return to state 514.

As described above, the list of corner points for a section polygon used to describe a section contour may be returned in state 546. This section contour may be mapped on the image of the section object in the image file. Pixels in the region defined by the section polygon may be made pointer-sensitive. The area of the section polygon may act as a “hotspot” which activates a function when selected. Pixels in the area defined by the section polygon may be associated with seat level maps corresponding to the section or the seat information page and other information relating to the particular section in the database.

FIGS. 15A-B illustrate a flowchart describing the mapping of a seat level map 50 according to an embodiment. FIG. 3 illustrates a seat level map according to an embodiment. The seat level map includes the general outline of the section with seat icons 52 representing the seating arrangement for a particular layout at the venue 12. The seat icons 52 are arranged in rows and the map may indicate row and seat designations. The seat map may include unreservable areas such as the stage, control booth area, sound station, and press area. The seat map may also show the locations of exits and designated seating for the disabled.

According to the present embodiment, in an unmapped seat map, the seat icons are empty (white) regions bordered by a non-white, generally circular line. Once mapped, the seat circles may be marked by setting the pixels in the circle to a particular color. Although described as circles, the actual seat objects may have other geometric shapes, such as polygonal.

When the unmapped image file is opened, the “define scale” dialog box 270 (FIG. 6) may be displayed. The operator may be prompted to set DPI, map scale, focal point, and focal offset at state 600. The operator identifies the map as a seat map by checking the “seat map” checkbox 256.

The operator may set mapping and crawling options in state 602.

An exemplary mapping option is a maximum seat points option which sets the maximum circumference of a seat circle in pixels. This may prevent runaway contour following, for example, in the case of a broken circle. An exemplary default value for this option is fifty (50) pixels.

An exemplary crawling option is an automatic row advance which determines whether a row number or letter should stay the same or advance automatically with each mapped row.

A window may be provided to show pointer distance and angle from the focal point of the current seat, when mapped, under the pointer icon at 604.

To begin mapping a row of seat circles, the operator may select a “define row” command at 606. Using the pointer device, the operator may select a row by clicking on the first seat and last seat of the row to be mapped at 608. Aisles may be identified by associating a “jump aisle” flag with the last seat in a row section adjacent an aisle. According to an embodiment, the “jump aisle” flag may be set by clicking on the last seat in the row section, and while holding a particular key, e.g., the “shift” key, clicking on the first seat in the row section across the aisle. Consider the selection of row D in FIG. 3. For a left to right (west-east) mapping operation, the operator first clicks on seat (icon) D28, then clicks on seat D2. With the shift key depressed, the operator clicks on seat D101 and releases the shift key. The operator clicks on seat D114. With the shift key depressed, the operator clicks on seat D1 and releases the shift key. The operator then clicks on seat D27 to complete the selection of row D.

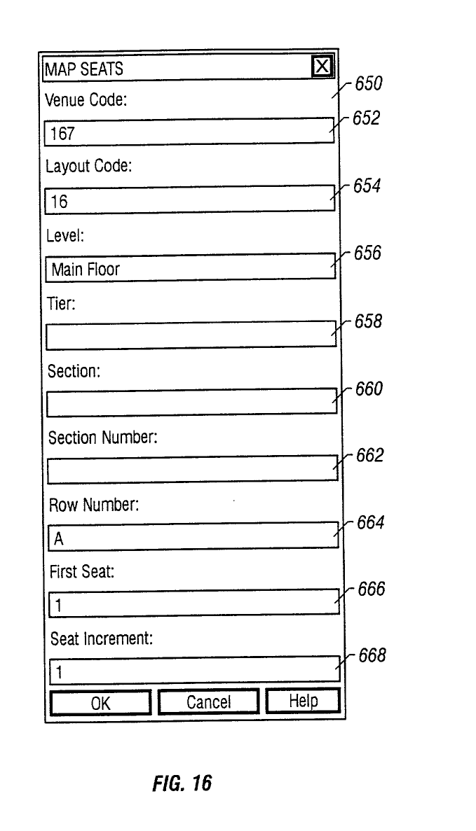

The operator may select a “find objects” command at 610. As shown in FIG. 16, a “map seats” dialog box 650 may be displayed to prompt the operator to enter information relating to the seats at state 612. If the row being mapped is the first in the seat map at state 614, the operator may be prompted to enter the venue code and layout code for the seat map. If the row being mapped is not the first row map, at 618, the operator may be prompted to enter in the appropriate field the section level 656, tier name 658, section name 660, and/or section number 662. The dialog box 650 may also include fields for entering row number 664, a first seat number 666, and a seat increment value 668.

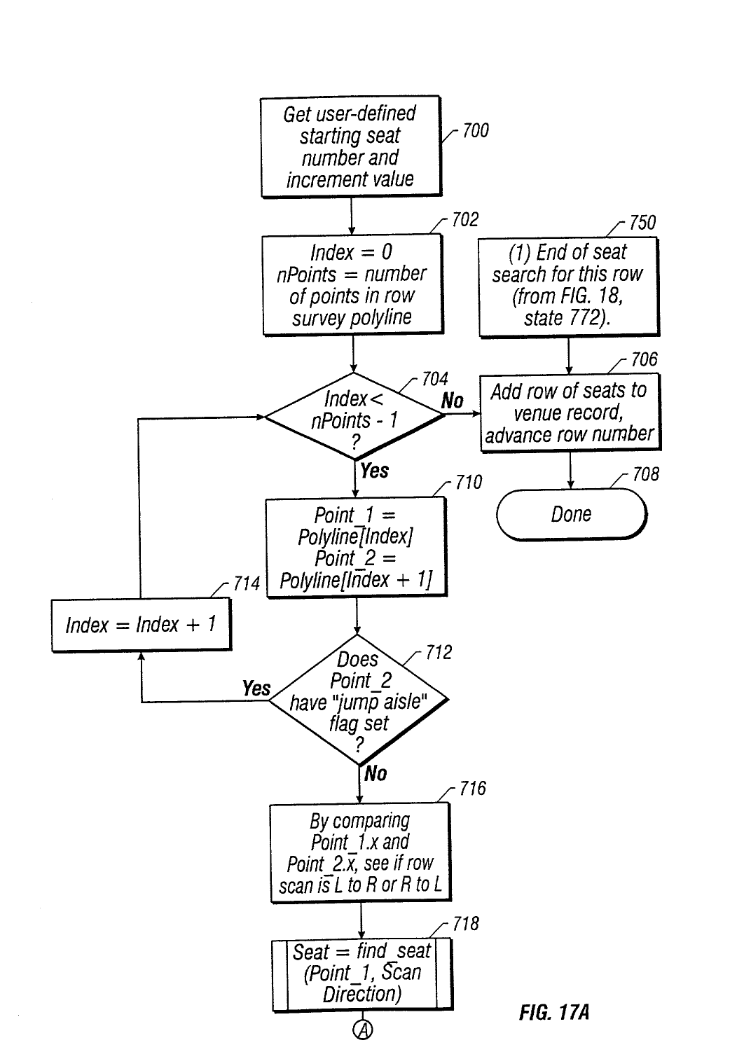

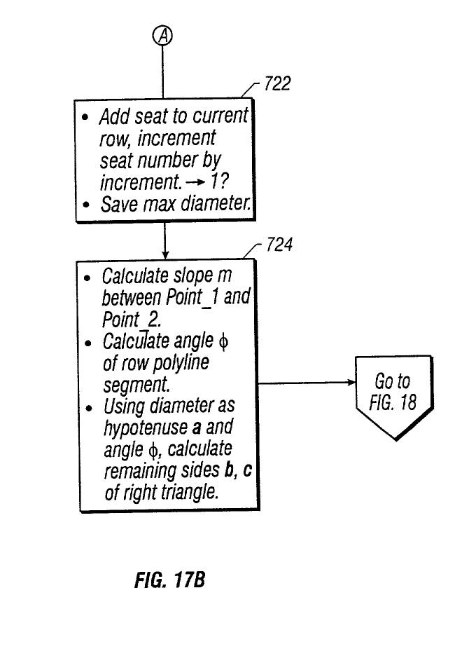

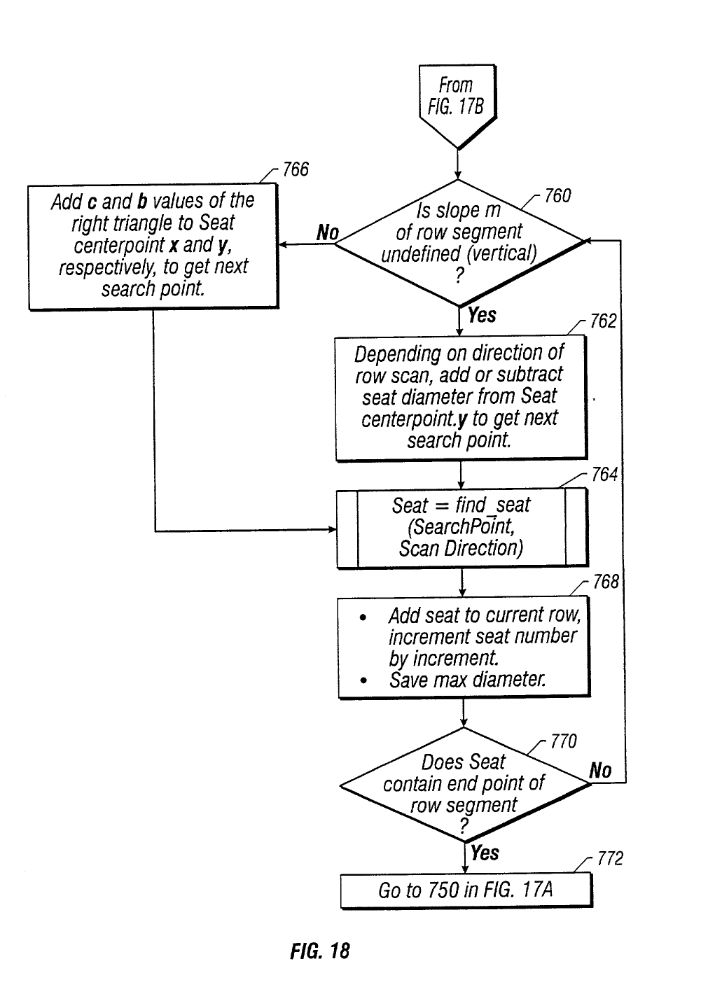

A row finding operation, described below in connection with FIGS. 17 and 18, may be carried out at state 622. If the mapped row is determined not to be the final row in the seat map at state 624, the operation may return to state 608 to map the next row. If the mapped row is the final row, the seat mapping operation may terminate at state 626.

FIGS. 17A-B illustrate a flow chart describing a row finding operation according to an embodiment. The starting seat designation and increment value may be entered by the operator or preserved from a previous row mapping operation.

At state 702, an “Index” value is set to “0” and an “npoints” value is set to the number of points in the row survey polyline, e.g., six (6) for the exemplary operation on row D described above in connection with FIG. 3, where two points were selected for each row section.

The “Index” value is compared to the value “(nPoints−1)” at state 704. If “Index” equals “(nPoints−1)” , which may occur when the last row section has been mapped, the mapped row may be added to the venue record and the row number may be automatically advanced at state 706, and the row finding operation may be terminated at state 708.

If “Index” is determined to be less than “(nPoints−1)” at state 704, a “Point_{—}1” is defined as “Polyline[Index]” and a “Point_{—}2” may be set to a value “Polyline[Index+1]” at state 710.

If it is determined that Point_{—}2 has an associated “jump aisle” flag at state 712, “Index” may be incremented “1” at state 714 and the operation may return to state 704.

The pixel coordinates of a current “Point_{—}1” may be compared to a current “Point_{—}2” at state 716 to determine whether the row scan direction is from left-to-right (eastward) or right-to-left (westward).

A seat finding operation in the row may be carried out using “Point_{—}1” as a starting point and the row scan direction at state 718. The seat finding operation may be used to find the seat contour from a start point inside the seat circle, trace “on” pixels on the inner contour of the seat circle, and from the “on” pixel coordinates, determine a center point and a maximum diameter 2R for the seat circle.

Once the seat circle is mapped, the seat information may be added to the current row, the seat number incremented a defined or default value, and the maximum diameter 2R of the seat circle stored at state 722.

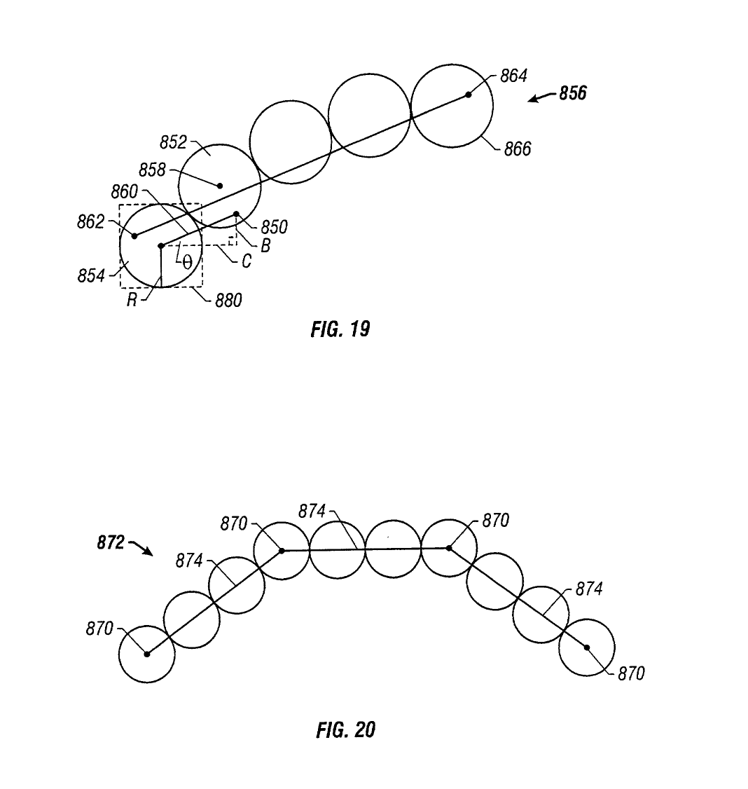

As shown in FIG. 19, the row finding operation may be used to determine a new starting point 850 for the for the seat finding operation on an adjacent seat circle 852 after the first seat circle 854 has been mapped, and continue this operation until all seats in the row 856 have been mapped. Assuming all of the seat circles in the row have approximately the same diameter, and that the row does not have an excessive curvature, a reasonable approximation for the center point 858 of an adjacent circle 852 may be found by extending a line 860 having a length equal to the diameter of the first circle from the center point of the first circle in the scanning direction along the slope of the line extending between “Point_{—}1” 862 and “Point_{—}2” 864 which lie in the first 854 and last seats 866 of the row, respectively.

A slope m may be determined from the x, y coordinates (x1, y1, x2, y2) of “Point_{—}1” and “Point_{—}2,” respectively. From slope m, an angle θ of a right triangle may be determined. The values of m and θ may be determined, for example, using the Java code segments:

(1) double slope=(double)(p2.p.y-p1.p.y)/(double)(p2.p.x-p1.p.x); and

(2) double angle=Math.atan(slope).

Using maximum diameter 2R as the hypotenuse A of a right triangle of angle θ, remaining orthogonal sides B and C may be determined, for example, using Java code segments:

(1) int A=seat.diameter;

(2) int B=(int)((double)A*Math.sin(angle)+0.5); and

(3) int C=(int)((double)A*Math.cos(angle)+0.5).

According to an embodiment, the “0.5” value is added to the round up to the next pixel.

FIG. 18 continues the flow diagram for FIG. 17. If slope m is determined to be undefined, i.e., vertical, at state 760, the hypotenuse A is added or subtracted, depending on the direction of travel (north-south or south-north), to the y coordinate of the seat center point to get the next search point at state 762. A seat finding operation may be performed using this new search point at 764.

If slope m is determined to have a value, rather than being undefined, at state 760, the C and B values of the right triangle are added to seat center point x and y, respectively, to get the next search point at state 766. A seat finding operation may be performed using this new search point at state 764.

Using data from the seat finding operation, the seat is added to the current row, the seat number is incremented by the defined or default increment value, and the maximum diameter 2R of the current seat saved at 768.

If it is determined in state 770 that the seat contains the last point of the row segment, e.g., seat D27 in the exemplary row selection described above in connection with FIG. 3, the seat search may be ended for this row at state 750 (FIG. 17A). The row of seats may be added to the venue record, and row number advanced at state 706, and the row finding operation may be terminated at state 708.

If it is determined at state 770 that the seat does not contain the end point of the row segment, the next search point is determined using the coordinates of the center point of the current seat.

If the row has a large curvature, as shown in FIG. 20, it may be advantageous for the operator to select several seat points 870 in objects in a row 872 to be used as reference points “Point_{—}1” and Point_{—}2”. This operation effectively defines “sub rows” 874 with section lines having slopes that more accurately represent the immediate slope of the curvature of the row.

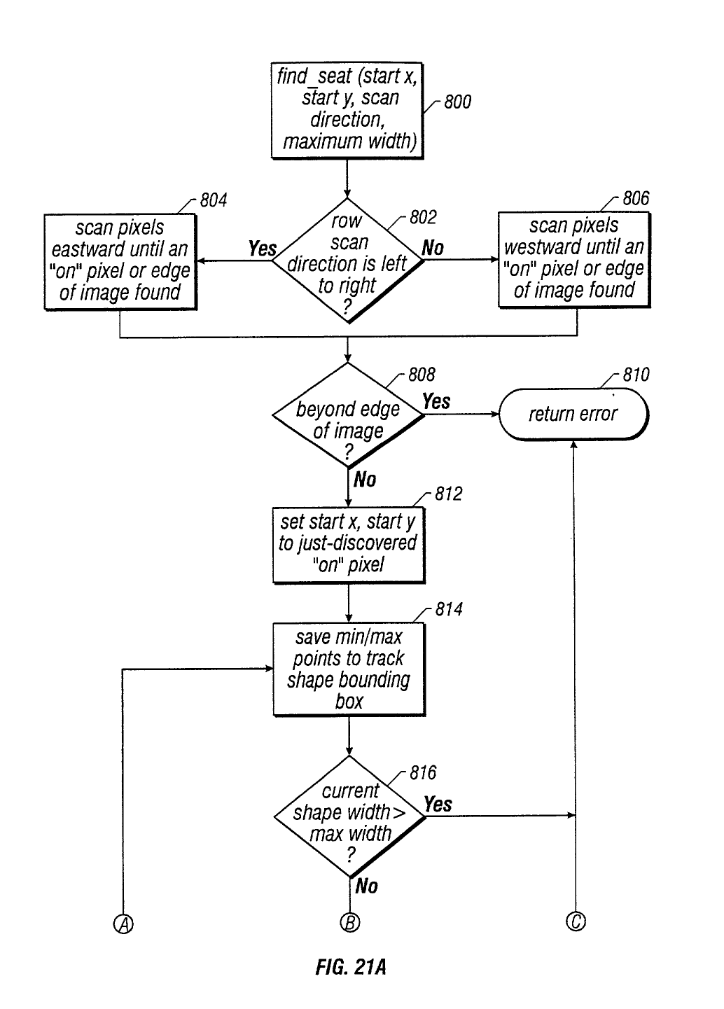

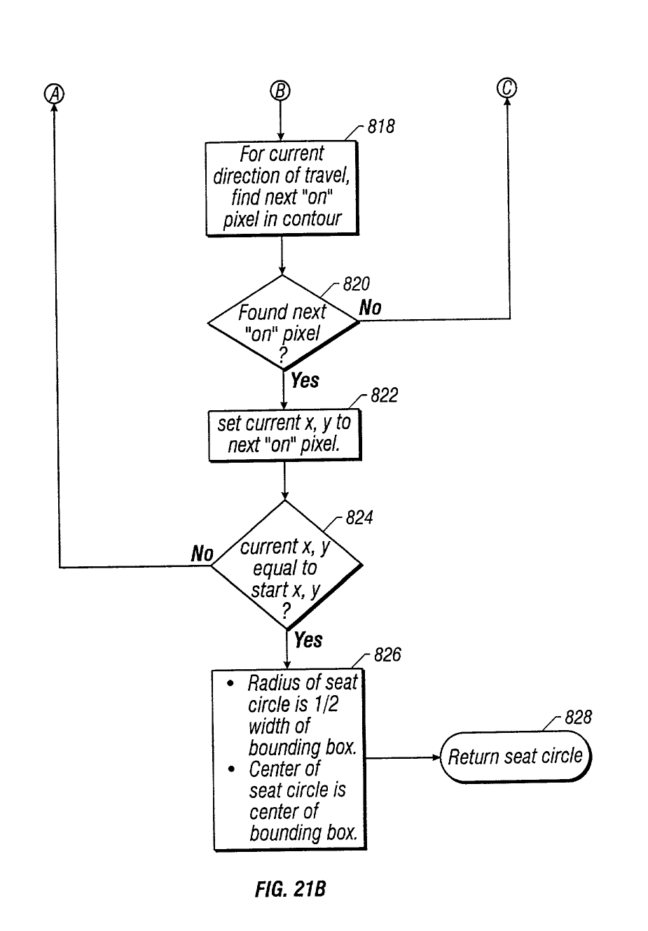

FIGS. 21A-B illustrate a flow diagram describing the seat finding operation. The seat finding operation passes in the values of the x, y coordinates of the starting point, the scan direction, and the defined or default maximum width in state 800. The scan direction may be determined in state 802. Starting from start point coordinates x0, y0, pixels may be scanned eastward or westward in 804 and 806, respectively, until an “on” pixel is located to determine an edge of the image. If the scan reaches an edge of the seat map without encountering an “on” pixel, an error value may be returned in state 810. This may occur in the case where the start point was selected outside of a seat circle in state 808.

The first “on” pixel may be used to set the starting x, y coordinates for an edge follower operation such as that described above in connection with FIGS. 11 and 12. Starting with the start point coordinates, minimum and maximum points may be stored to track the shape of a bounding box for the seat circle at state 814. These min/max points may be used to determine whether the shape width exceeds the defined or default maximum width at state 816. If so, an error value may be returned at state 810.

If no adjacent “on” pixel is found in state 820, an error value may be returned in state 810. This may occur in the case of searching an object with an open contour.

If the next adjacent “on” pixel is located, the current x, y coordinate is set to that of the next “on” pixel.

The x, y coordinates of the current pixel may be compared to that of the start pixel in state 824. If the current pixel is not the start pixel, the operation may return to state 814.

If the current pixel equals the start pixel, it is assumed that the entire contour has been mapped.

Using the stored min/max values, a bounding box 880 (FIG. 19) may be calculated that contains the seat object. Although the seat icon may have a geometric shape other than a circle, the radius R for a seat circle representing the seat icon may be returned in state 826. The radius R is one-half the width of the bounding box 880. The coordinates of the center point of the seat circle may be set to the center of the bounding box 880 in state 826. These values may be returned in state 828.

The data obtained from the mapping operations on the image files for the section level and seat level maps corresponding to a particular venue may then be transcribed to a number of text files for transport into the database or directly uploaded. According to the present embodiment, these text files may include: a LAYOUT file; a COORD file; a SECTION file; a ROW file; and a SEAT file.

The LAYOUT file may contain basic information about a particular layout of a venue. There may be one or more layouts for a venue.

A LAYOUT file according to an embodiment may have the following format:

LAYOUT_CODE|VENUE_CODE|IMAGE_FILE|IMAGE_WIDTH|IMAGE_HEIGHT|NU M_SEATS|NUM_SECTIONS|SCALE|DPI|FOCAL_POINT|LAST_UPDATE

16|167|labovard_exploded.gif|359|371|1161|2|0.002684|72|234,260|10/22/99.

LAYOUT_CODE: Code corresponding to layout (e.g. 16 (Theatre), 5 (Play), 8 (Concert), etc.)

VENUE_CODE: Code that uniquely identifies a venue. Same for every layout of a venue.

IMAGE_FILE: Name of image file that contains the top-level map, which may be a section-level or seat-level map, depending on the size and configuration of the venue.

IMAGE_WIDTH: Width of the image file, in pixels.

IMAGE_HEIGHT: Height of the image file, in pixels.

NUM_SEATS: Number of seats total in this layout of the venue.

NUM_SECTIONS: Number of sections total in this layout of the venue. This value may be “1” for a venue that does not distinguish different sections.

SCALE: Scale used in drawing the image file entered by the operator.

DPI: Dots per inch of the image file.

FOCAL_POINT: An X/Y position defining the “point of interest” within the image file.

The COORD file may contain geometric coordinates describing the outlines of sections and the center point/diameter of seats found within the image files that contain the various maps of the venue layout.

A COORD file according to an embodiment may have the following format:

COORD_ID|COORD_TYPE|COORD_DATA|VENUE_CODE

1|2|178,200,10,277,199,218,140,160,160,108,198,71,163,51,178,140,267,169,276,221,241,2 77,224|167

2|1|12,261,627|167

3|1|12,274,627|167

4|1|12,286,625|167

etc . . .

COORD_ID: Identifier for this shape instance.

COORD_TYPE: Qualifier describing the type of shape contained in the record.

COORD_DATA: The points/dimensions making up the shape in this record.

VENUE_CODE: Venue code to make the association between these shapes and a certain venue. See description in LAYOUT file, above.

The SECTION file may describe sections within this layout of the specified venue. For a venue that makes no section distinction, this file may contain the header line and one additional line/record describing the whole venue as a “section”.

A SECTION file according to an embodiment may have the following format:

SECTION_ID|SECTION_LEVEL|SECTION_TIER|SECTION|SECTION_NUM|VENUE_C ODE|LAYOUT_CODE|COORD_ID|ADVICE_ID|SEATPHOTO_ID|VIEWPHOTO_ID|IM AGE_FILE|IMAGE_WIDTH|IMAGE_HEIGHT|ELEVATION|SCALE|DPI|FOCAL_POIN T|FOCAL_OFFSET|LEGEND_POINTS|LAST_UPDATE

1|Main Floor||||167|16|1 |-1|-1|-1|labovard_floor.gif|680|861|0|0.009660|72|342,763|0|8,10,128,129|10/22/99.

2|First Balcony||||167|16|770|-1 |-1 |-1|labovard_balc.gif|674|582|0|0.009660|72|335,468|36|6,7,126,126|10/22/99.

SECTION_ID: Unique numeric identifier for this section.

SECTION_LEVEL: String corresponding to section level name, if any.

SECTION_TIER: String corresponding to section tier name, if any.

SECTION: String corresponding to section name, if any.

SECTION_NUM: String corresponding to section number, if any.

VENUE_CODE: See LAYOUT description.

LAYOUT_CODE: See LAYOUT description.

COORD_ID: Corresponds to a record in the COORD file and references the identifier associated with polygonal shape record for this section.

ADVICE_ID: Defined later during a review input process.

SEATPHOTO_ID: Defined later during a review input process.

VIEWPHOTO_ID: Defined later during a review input process.

IMAGE_FILE: Name of image file that contains the map associated with this section, if any. If this is a one/no-section venue, this field will be empty, and the LAYOUT table will contain the top-level image map name.

IMAGE_WIDTH: Width of the image file, in pixels.

IMAGE_HEIGHT: Height of the image file, in pixels.

ELEVATION: Height from the floor to the front edge of the section.

SCALE : See LAYOUT description.

DPI: See LAYOUT description.

FOCAL_POINT: May be slightly different from the LAYOUT value and represents the position in the image file from which calculations may be made to establish distance to the real point of interest for patrons sitting in the seats in this section. Used in conjunction with the FOCAL_OFFSET, below. Usually placed at the middle of the front edge of the section.

FOCAL_OFFSET: A value, in feet, that specifies the distance from the

SECTION FOCAL_POINT to the LAYOUT FOCAL_POINT.

LEGEND_POINTS: Two X/Y points defining the size and location of the reference mini-map legend in the upper left corner of the image file for this section. May be defined only on seat maps of multiple-section venues, and when clicked on, may take a user back to the top level section map.

LAST_UPDATE: See LAYOUT description.

The ROW file may describe rows within each section of this layout of the specified venue. For a venue that has no seat-level maps (e.g., a large stadium) this file may contain no information other than the header line.

A ROW file according to an embodiment may have the following format:

ROW_ID|ROW_NUM|VENUE_CODE|LAYOUT_CODE|SECTION_ID|ADVICE_ID|SEA TPHOTO_ID|VIEWPHOTO_ID|LAST_UPDATE

1|A|167|16|1|-1|-1|-1|10/22/99

2|B|167|16|1|-1|-1|-1|10/22/99

3|C|167|16|1|-1|-1|-1|10/22/99 etc.

ROW_ID: Unique numeric identifier for this row.

ROW_NUM: String corresponding to row number.

VENUE_CODE: See LAYOUT description.

LAYOUT_CODE: See LAYOUT description.

SECTION_ID: See SECTION description. Associates row with a particular section.

ADVICE_ID: See SECTION description. Allows a reviewer to associate review information for an entire row of seats.

SEATPHOTO_ID: See SECTION description.

VIEWPHOTO_ID: See SECTION description.

LAST_UPDATE: See LAYOUT description.

The SEAT file may describe seats within rows within sections of this layout of the specified venue. For a venue that has no seat-level maps (e.g., a large stadium) this file may contain no information other than the header line.

SEAT_ID|SEAT_NUM|VENUE_CODE|LAYOUT_CODE|SECTION_ID|ROW_ID|COOR D_ID|ADVICE_ID|SEATPHOTO_ID|VIEWPHOTO_ID|LAST_UPDATE

1|101|167|16|1|1|1|2|-1|-1|-1|10/22/99

2|102|167|16|1|1|3|-1|-1|-1|10/22/99

3|103|167|16|1|1|4|-1|-1|-1|10/22/99 etc.

SEAT_ID: Numeric identifier for this seat.

SEAT_NUM: String corresponding to seat number.

VENUE_CODE: See LAYOUT description.

LAYOUT_CODE: See LAYOUT description.

SECTION_ID: See SECTION description. Associates seat with a particular section.

ROW_ID: See ROW description. Associates seat with a particular row.

COORD_ID: Corresponds to a record in the COORD file and references the identifier associated with the circle shape record for this seat.

ADVICE_ID: See SECTION description. Allows a reviewer to associate review information with a specific seat.

SEATPHOTO_ID: See SECTION description.

VIEWPHOTO_ID: See SECTION description.

LAST_UPDATE: See LAYOUT description.

These text files may be transmitted from the mapping operator machine 24 to the central site 16 for import into the venue database 18 (or directly uploaded).

Returning to FIG. 1, the user's machine 10, e.g., a general purpose computer, may communicate with the central site 16 through a network connection 14, e.g., the Internet, and access information in the venue database 18 corresponding to a selected venue 12.

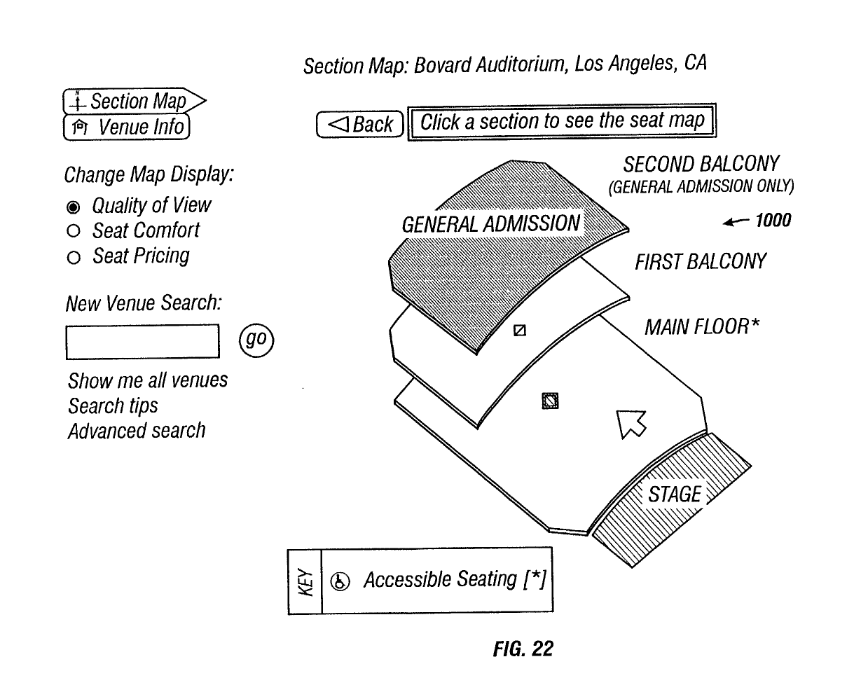

According to an embodiment, a screen display 1000 for an interactive section level map, shown in FIG. 22, may be displayed when a venue 12 is selected. The user may select a section, for example, by clicking on a desired section object with a pointing device, to access a seat level map corresponding to the selected section. The user may access a textual description and/or photograph(s) of the venue by selecting a “venue info” button in the screen display.

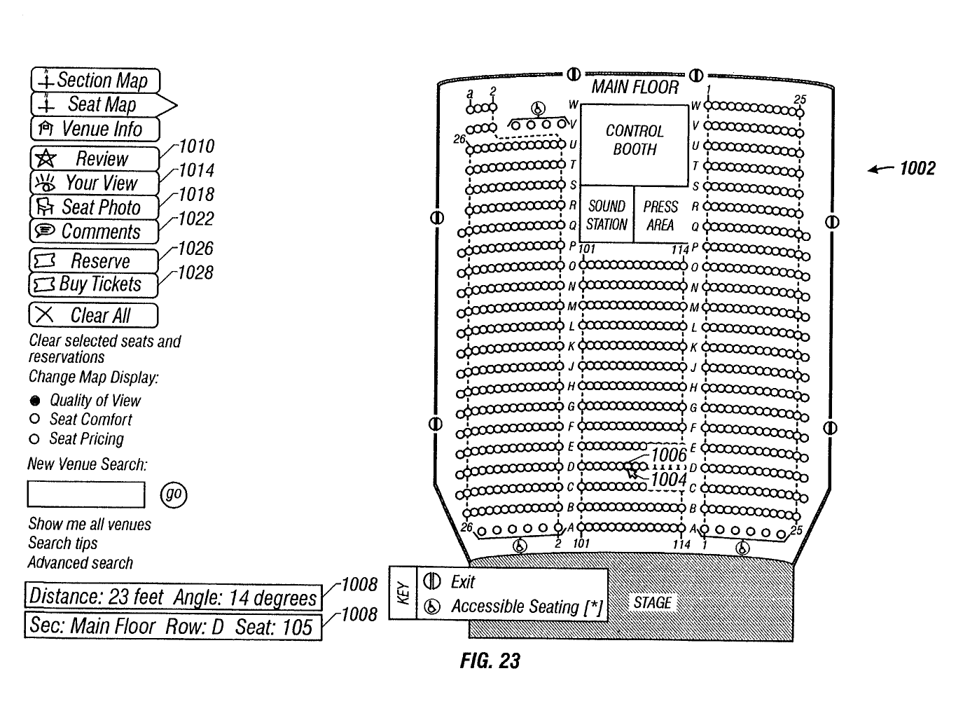

FIG. 23 is a screen display 1002 for an interactive seat level map according to an embodiment. As the user moves a pointer icon 1004 over seat objects 1006 in the seat level map, the approximate distance and angle from the focal point may be calculated from the map scale data and displayed in an area 1008 of the screen display.

The user may select a seat by clicking on the associated seat object 1006 in the map with the pointing device 1004. The selected seat may be marked, for example, by highlighting the border line of the seat circle, or by setting the pixels in the seat circle to a designated color or shading.

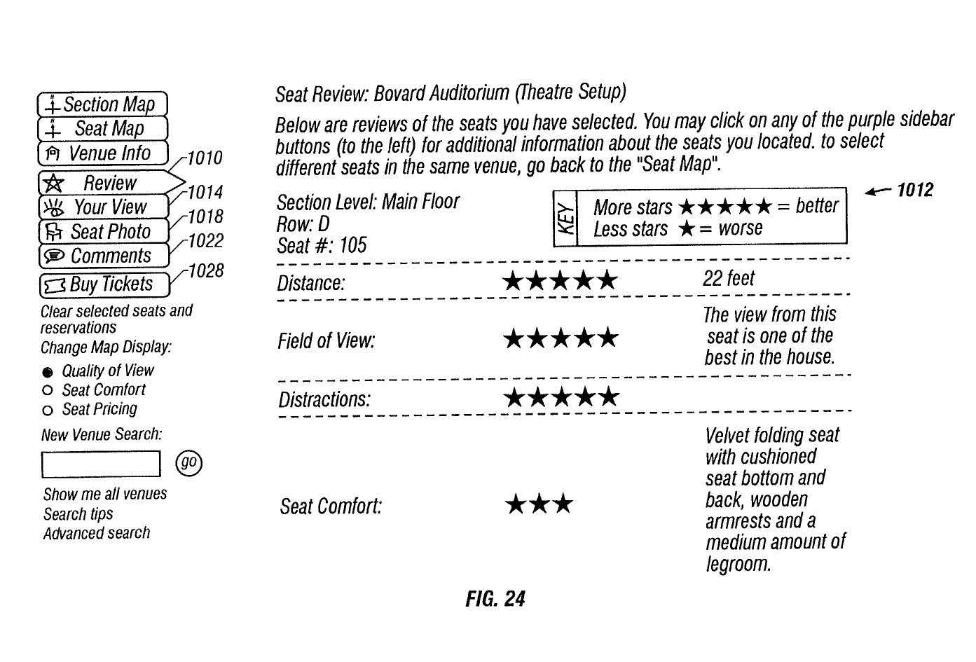

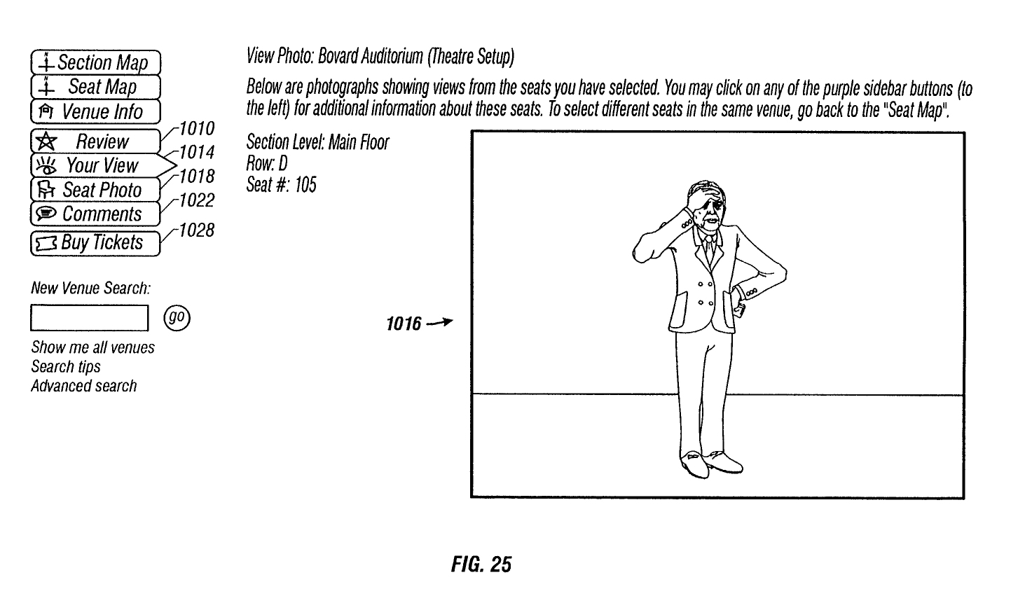

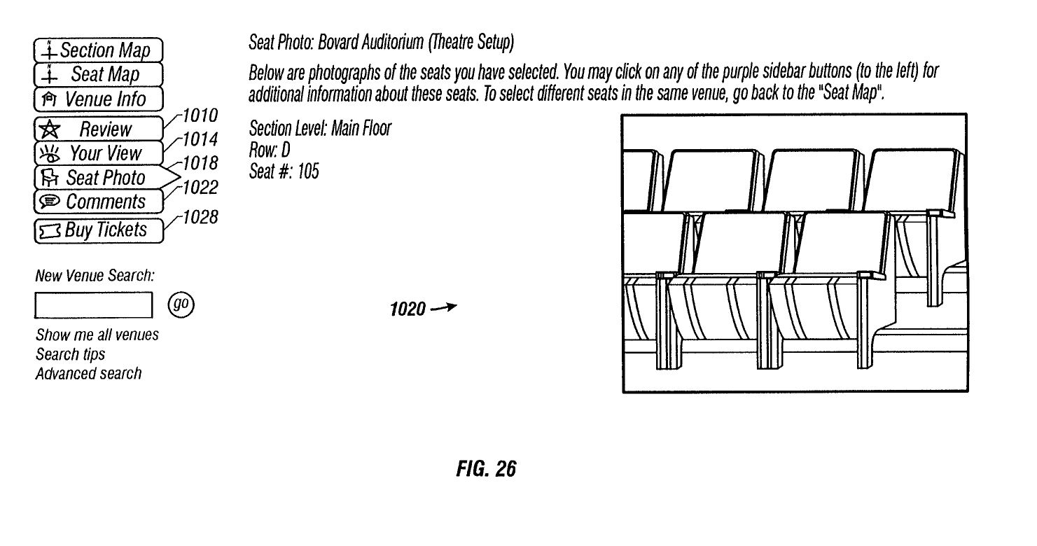

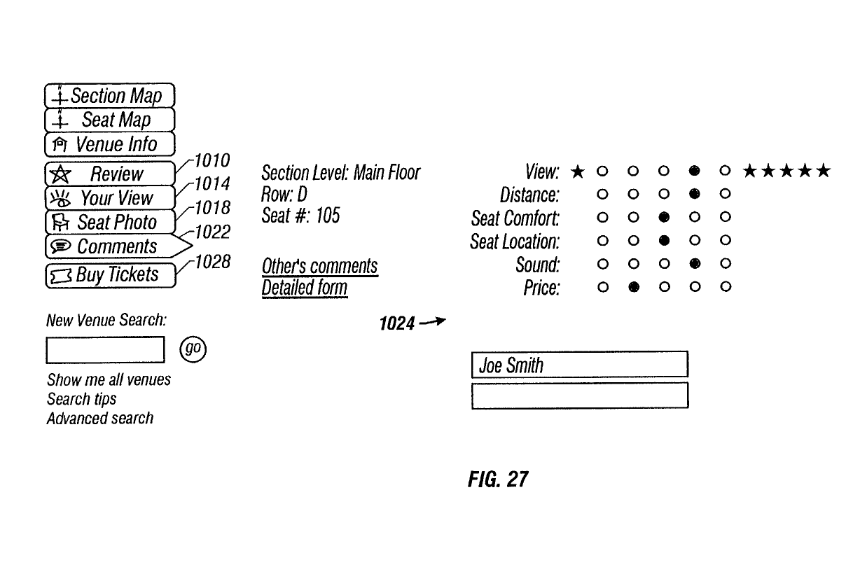

By clicking a “review” button 1010 in the screen display, the user may access a textual review 1012 of the selected seat from the venue database 18, as shown in FIG. 24. By clicking a “your view” button 1014, the user may access an image 1016 of a representative view or the actual view from the seat, as shown in FIG. 25. By clicking on a “seat photo” button 1018, the user may access an image 1020 of a representative seat or the actual seat, as shown in FIG. 26. By clicking on a “comments” button 1022, the user may access comments 1024 by other patrons who have used the selected seat or a representative seat in that section, as shown in FIG. 27.

The user may reserve the selected seat for an event by clicking on a “reserve” button 1026, if such reservations are available. The central site 16 communicates with a ticketing service site 26 which is able to track reservations and sales of tickets for particular seats in the venue 12 for particular events. According to an alternate embodiment, a ticketing service is performed at the central site.

The user may purchase a ticket for the selected seat for an event by clicking on a “buy tickets” 1028 button. The central site 16 communicates with the ticketing service site 26 to determine availability, and if a ticket is available, may complete the transaction by accessing funds through a financial/credit processing institution site 28 on behalf of the user.

The user may reserve or purchase tickets for a seat from the seat map, or any dependent screen, e.g., a view image screen (FIG. 25), seat image screen (FIG. 26), description (FIG. 24) or review screen (FIG. 27).

According to an embodiment, seats that have already been reserved or sold may be marked, for example, by placing a geometric shape, e.g., a square, of a different (or no) color in the seat circle, by highlighting the border line of the seat circle, or by setting the pixels in the seat circle to a designated color or shading. According to another embodiment, a screen display is invoked that notifies the user that the seat is unavailable for that event.

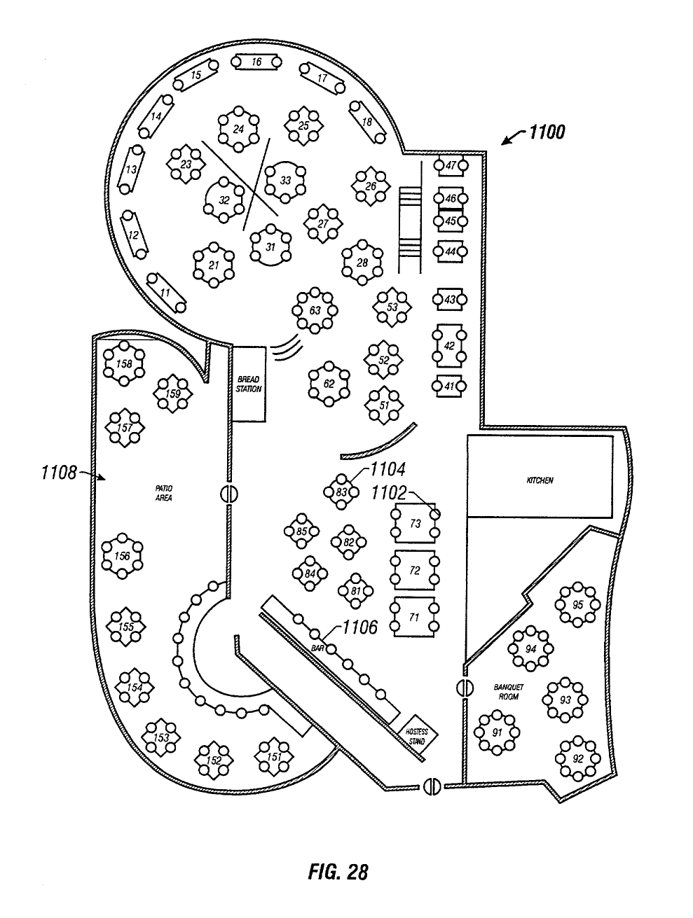

According to alternate embodiments, maps for other environments in which seats may be assigned and reserved may be made interactive. FIG. 28 illustrates an interactive map 1100 for a restaurant. The seats 1102, tables 1104, bars 1106, and sections 1108 may be made pointer-sensitive, interactive, and designated with an object identifier using the seat and section mapping operations. The object identifiers may correspond to a defined or default convention. Examples of object identifiers include, for example, “Patio Area”, “Section A”, “Table 83”, and “Seat 4”. The various objects of the interactive map may be associated with information in the venue database.

A user may access the interactive map from the central site 16 (FIG. 1) over the Internet 14. The user may make a reservation online by selecting a desired table with a pointer device and entering reservation information including, for example, a desired date and time, and user information including, for example, a name and contact phone number or email address. This information may be checked against a reservation file in the database 18, and if available, stored as a reservation in the file. The user may be informed whether or not the reservation was successful with a screen display, which may include a reservation confirmation number if successful.

According to another embodiment, the user may hold a seat for a limited time. An entry in the reservation file may include a time stamp and may expire within a given time period, for example, 6 hours or a day. While the seat is held, it is treated as reserved. Other users may not reserve that seat and the vendor may not be able to change the ticket price for the seat. The user may leave the site and return at another time to confirm the reservation and purchase a ticket for the seat. The central site may recognize the user holding the seat by the user's member log-in or by the user's machine's IP address. If the user does not respond within the given time period, the reservation may expire. The held seat may have a different color in the seat map displayed on the machine of the user holding the seat than in seat maps displayed on other user machines, on which the seat would appear to be purchased or otherwise reserved.

According to various other embodiments, the user may be able to exercise special purchasing options. These purchasing options may include subscription purchases, group purchases, a “Best Available” pricing option, and online bidding for a seat. As described above, when a seat, or seats, has been purchased, it will not be made available for purchase by other users and the purchased seats may be designated as such on the respective interactive seat map, for example, by highlighting with a particular color.

A user may purchase several tickets for a selected seat by subscribing to an event. For example, the user may purchase tickets for an entire sporting season. By selecting the seat and purchasing a subscription, the user would automatically purchase a ticket for the selected seat for each game of the season. The central site 16 may automatically send an email to the user at the end of the subscription, for example, the sporting season, thereby giving the user the opportunity to subscribe for the next season.

A group of users may purchase a block of seats for an event or a subscription. Members of the group may access a secured site to purchase tickets for seats not available to non-members. The secured site may be password protected. In the secured site, the seats reserved for the group may be designated by a particular color indicating their availability to members. On other user machines, the seat objects would have a color indicating they were purchased or otherwise reserved. The tickets may be made available to group members at a group discount.

A user may request a “Best Available” seat for an event based on specific criteria. The criteria may include, for example, price, distance from the stage, and viewing angle from the seat. The central site 16 may prompt the user for the desired criteria. The central site would then determine which available seats exactly matched, or most closely matched, the selected criteria and present a list of those seats to the user. The user may then reserve, hold, purchase, or decline any of the listed seats.

A user may bid for a selected seat by known on-line bidding processes.

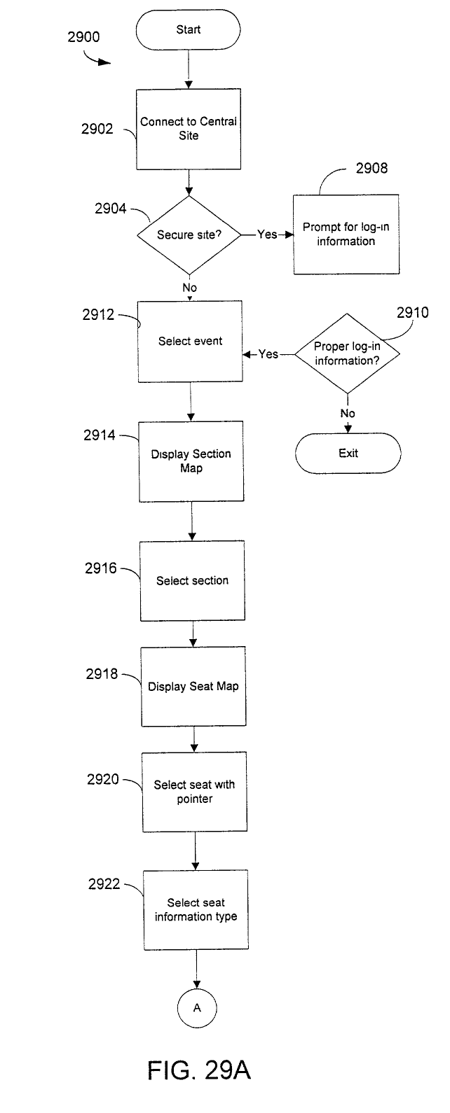

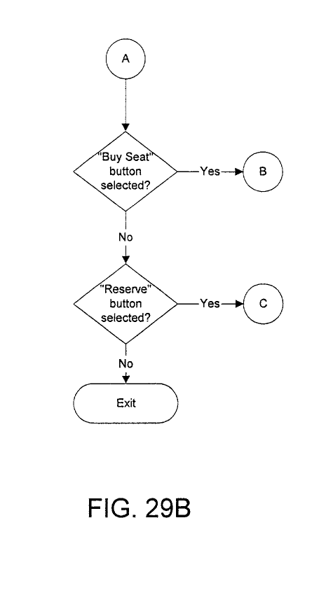

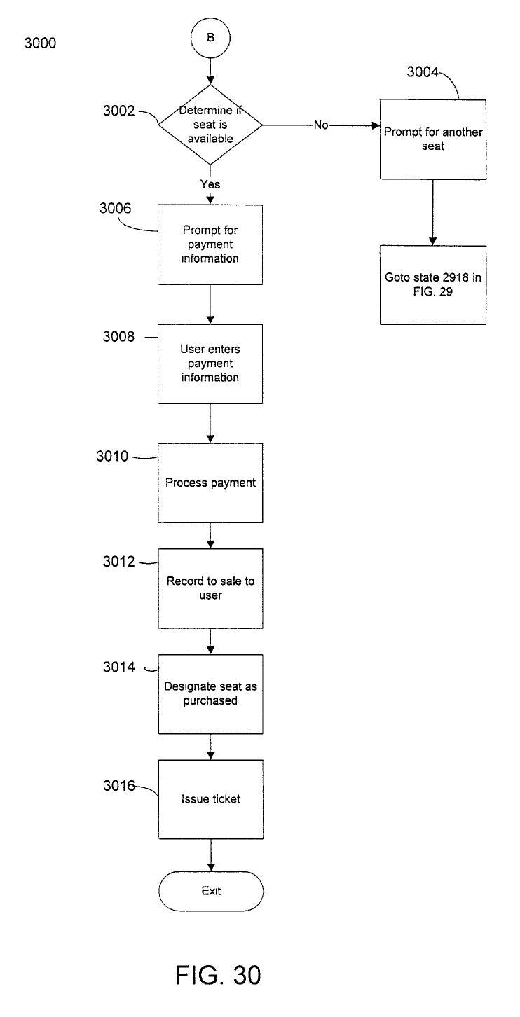

FIGS. 29A and 29B illustrate a flow chart describing a seat selection operation 2900 according to an embodiment. The user 10 connects to the central site 16 over the network connection 14 in state 2902. If the site is not secured, the user may be prompted to select a venue in state 2906. If the user enters a secure site in state 2904, for example, a member site or a group member site, the user may be prompted for log-in information in state 2908. If the user enters the proper log-in information in state 2910, the user may be prompted to select a venue in state 2906. Otherwise, the operation may exit.

Once the venue is selected, the user may be prompted to select an event in state 2912. A section map corresponding to the selected venue and event may be displayed in state 2914. The user may select a desired section with a pointer device in state 2916. A seat map corresponding to the selected section may be displayed in state 2918. Seats which are not available for reservation or purchase may be designated by particular colors or other graphic indicia. The user may select a seat object in state 2920. The user may then select desired information about the selected seat in state 2922, for example, textual reviews and comments, and photographic images representative of the selected seat or its view. This seat information may be retrieved from the venue database 18 and displayed for the user 10 in state 2924. If the user declines to purchase or reserve the seat in states 2926 and 2928, the operation may hold or exit.

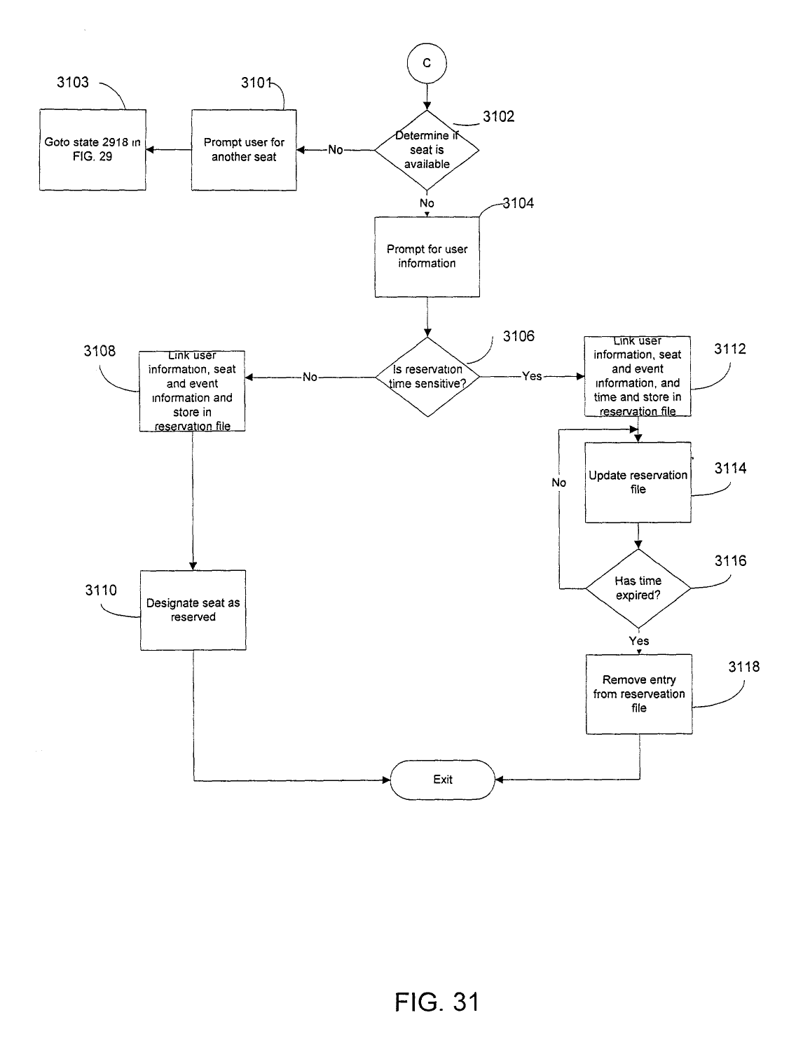

FIG. 30 illustrates a ticket purchasing operation 3000 according to an embodiment. If the user selects the “Buy Tickets” button 1028 (FIG. 23) in state 2926 (FIG. 29), the central site 16 may determine if the selected seat is available for purchase in state 3002. If the seat is not available, the user may be prompted to select another seat in state 3004. Otherwise, the user may be prompted for payment information in state 3006. Payment information may include user information, such as user name, phone number, address, email address, etc., and account information, such as credit/debit card number, expiration date, and payment zip code. The user may enter the payment information in state 3008, which is processed in state 3010. If the transaction is approved by the payment processor 28, the sale may be recorded in state 3012 and the seat designated as purchased in the interactive seat map in state 3014. The ticket may be issued to the user electronically or physically (ie. printed and mailed) in state 3016, or printed and held at the venue.

FIG. 31 illustrates a seat reservation operation 3100 according to an embodiment. If the user selects the “Reserve” button 1026 (FIG. 23), the central site 14 may determine if the seat is available for reservation in state 3102. If not, the user may be prompted to select another seat in state 3101, and return to state 2918 in FIG. 29. If so, the user may be prompted for user information in state 3104.

If the reservation is determined not to be time sensitive in state 3106, the user information may be linked with the seat and event information in the reservation file in state 3108 and the seat designated as reserved in the seat map, for example, by highlighting with a particular color, in state 3110.

If the reservation is determined to be time sensitive, for example, a reservation holds a seat for a limited time as described above, the user information may be linked with the seat and event information as well as a time stamp of the reservation in state 3112. The reservation file may be updated periodically in state 3114. If it is determined that the user has elected to purchase the ticket, for example, by pressing the “Buy Tickets” button 1028, the operation continues at state 3006 (FIG. 30). Otherwise, the time entry in the reservation entry is examined and, if it is determined to have expired, the entry may be removed from the reservation file in state 3118. Otherwise, the operation may continue at state 3114.

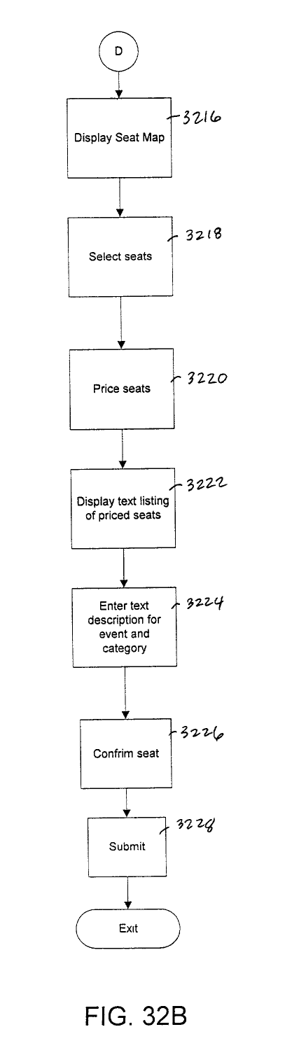

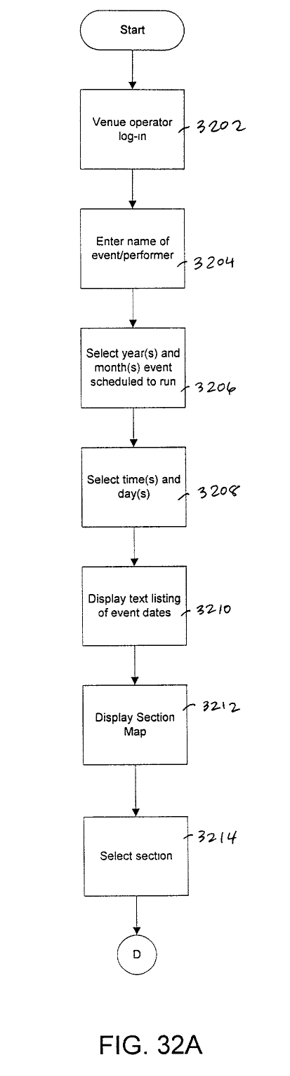

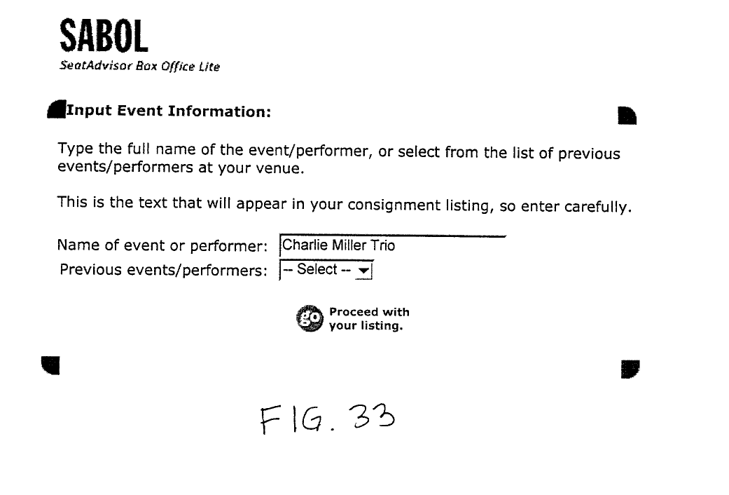

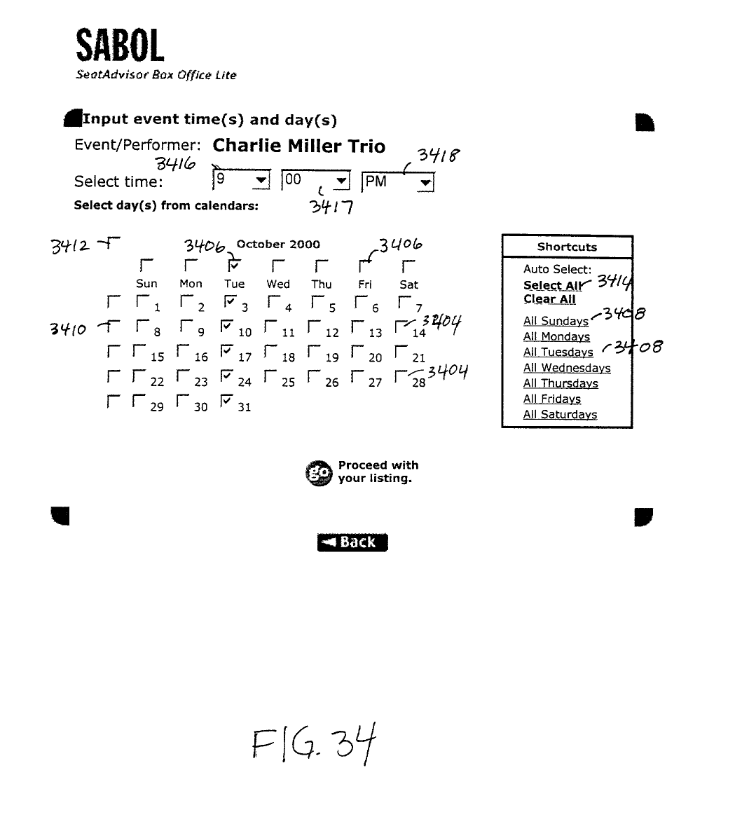

The seat prices for event dates at a venue may be set by a venue operator. FIGS. 32A and 32B illustrate a flow chart describing a seat pricing operation 3200 according to an embodiment. After logging in to the system in state 3202, the venue operator may be prompted to enter a name for the event or performer in state 3204. FIG. 33 illustrates an exemplary display screen 3300 corresponding to state 3204. The venue operator may be prompted to enter the year(s) and month(s) the event is scheduled to run in state 3206. The venue operator may select time(s) and day(s) for the event in state 3208. FIG. 34 illustrates an exemplary display screen 3400 corresponding to state 3208. The venue operator may select individual dates by selecting date boxes 3402. The venue operator may select weekly dates in the month, for example, all Mondays in a month, by selecting day boxes 3206 or day tags 3408. The venue operator may select an entire week by selecting a week box 3410. The venue operator may select all days in a month by selecting month box 3412 or “Select All” tag 3414. The venue operator may also enter the scheduled time for the event in time entry boxes 3416-3418.

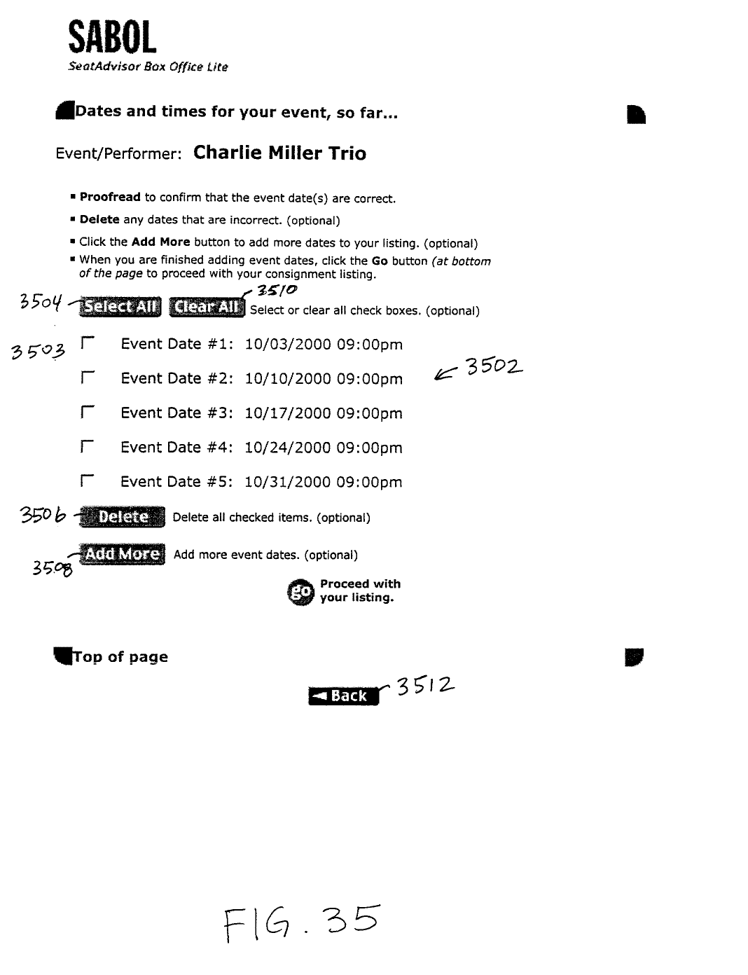

A confirmation screen 3500 (FIG. 35) may then be displayed in state 3210. The confirmation screen 3500 may include a textual list 3502 of event dates and times. The user may confirm the listing and proceed, or edit the list. The list may be edited directly by selecting individual entries with entry boxes 3503 or by selecting all entries with a “Select All” button 3504. The selected entries may be deleted with a “Delete” button 3506. The venue operator may also edit the list by clearing all entries with “Clear All” button 3510. The venue operator may also edit the list by adding more entries with an “Add More” button 3508.

According to an embodiment, the display screens presented in the seat pricing operation 3202 may include a “Back” button 3512 which enables the venue operator to return to a previous screen to edit an earlier selection.

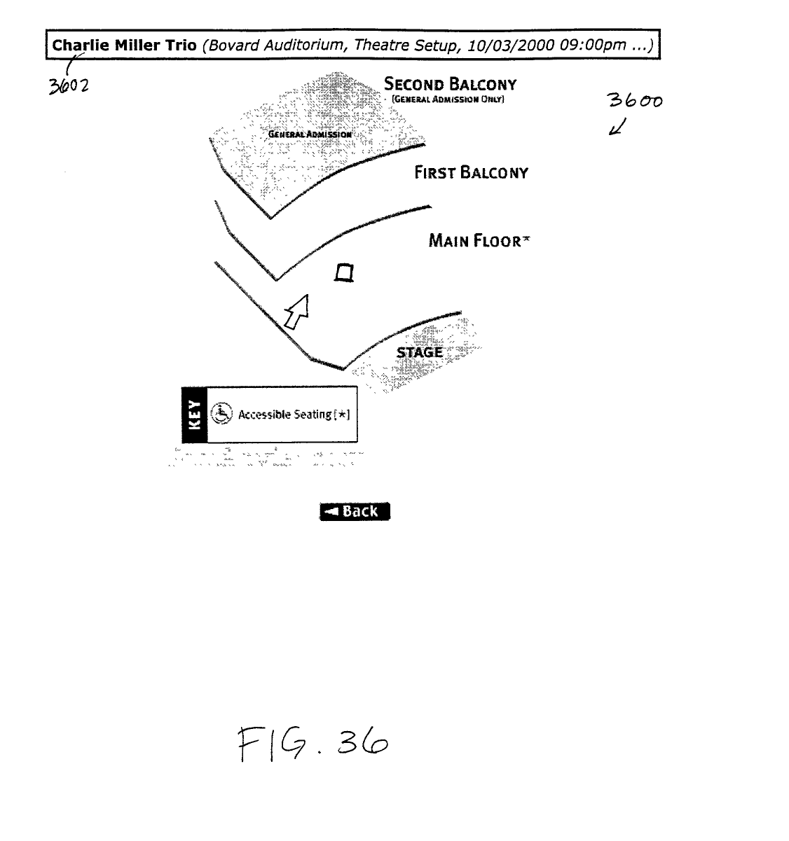

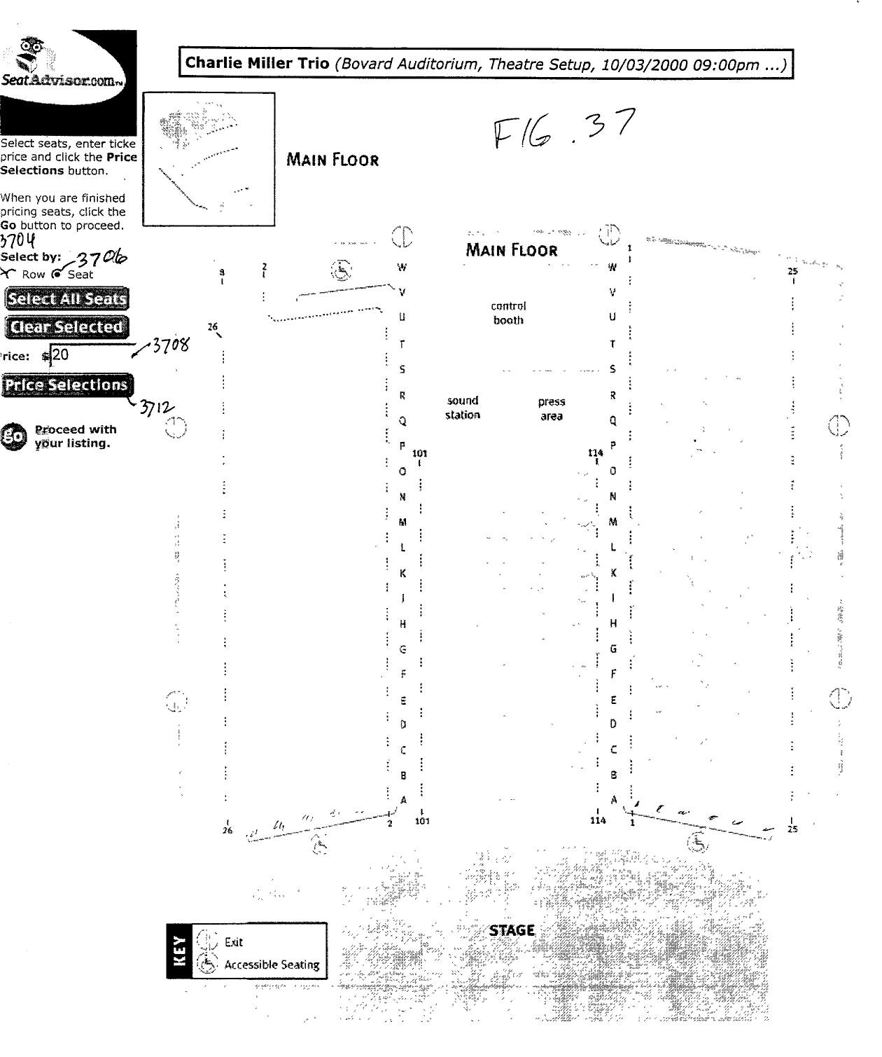

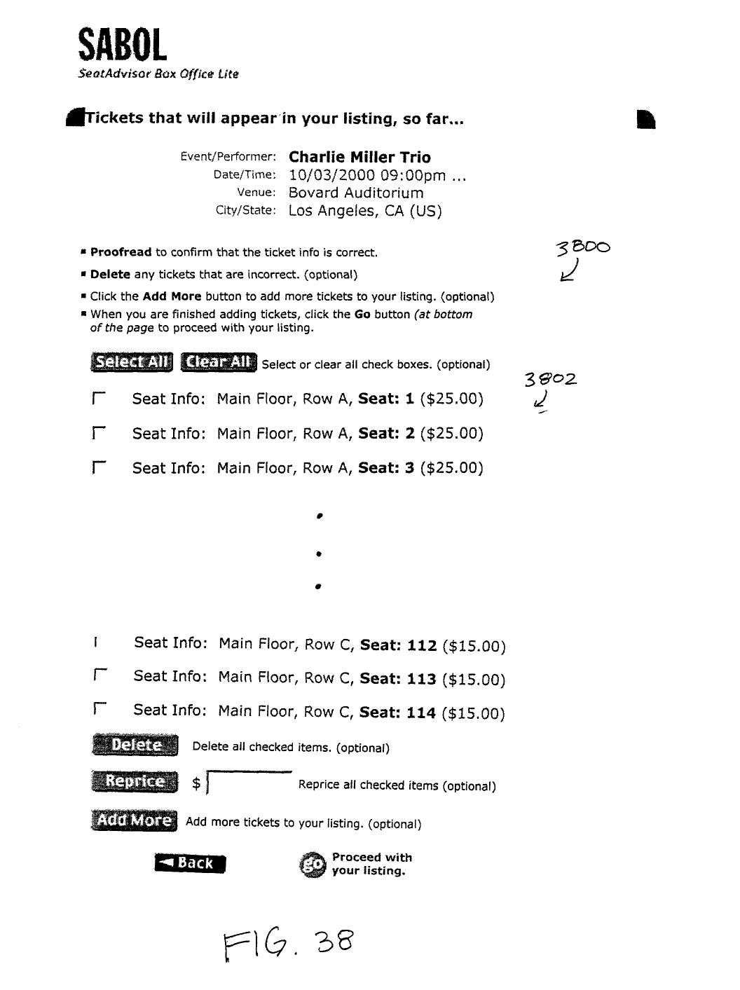

Once the entries are confirmed, the venue operator may be presented with a section map 3600 (FIG. 36) for his venue in state 3212 with a banner 3602 stating the name of the event/performer and event dates. The venue operator may select a section with seats to be priced in state 3214. A display screen 3700 with corresponding seat map 3702 may be displayed in state 3216. The venue operator may select seats to be priced in state 3218 by row or individually by toggling box 3704 or 3706, respectively. If selecting by row, clicking on any seat object in the row will cause all seat objects in the row to be selected. Selected seats may be presented as highlighted with a particular color or a bold contour outline. The venue operator may enter a ticket price for the selected seat(s) 3708 in dollar amount box 3710 and then assign this price to the selected seat(s) in state 3220 by selecting “Price Selections” button 3712.

The operation described in relation to states 3218 and 3220 may be repeated to price other seat(s) differently. For example, seats closer to the stage may have higher prices than other seats. Seats with a particular price may be highlighted with a color different than that of non-priced seats and differently priced seats. Once all desired seats have been priced, a confirmation screen 3800 (FIG. 38) may be displayed in state 3222. The confirmation screen 3800 may include a textual list 3802 of priced seat entries. Each entry may include, for example, seat number, location, and price. The list may be edited directly, or indirectly by backing up to previous screens with “Back” button 3512.

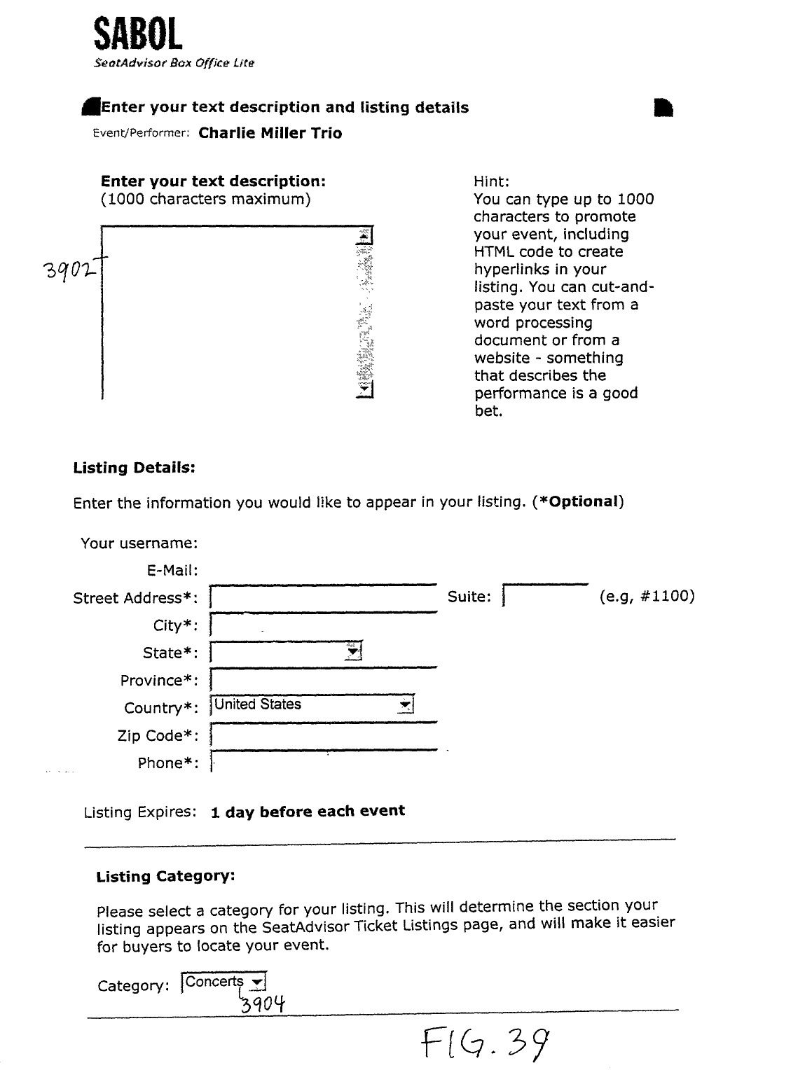

The venue operator may enter a textual description for the event and an event category in state 3224. FIG. 39 illustrates exemplary display screen 3900 corresponding to state 3224. The display screen 3900 may include description entry box 3902 and category entry box 3904. The text entered in the description entry box 3902 may be displayed to users of the seat selection and ticket purchasing services described above.

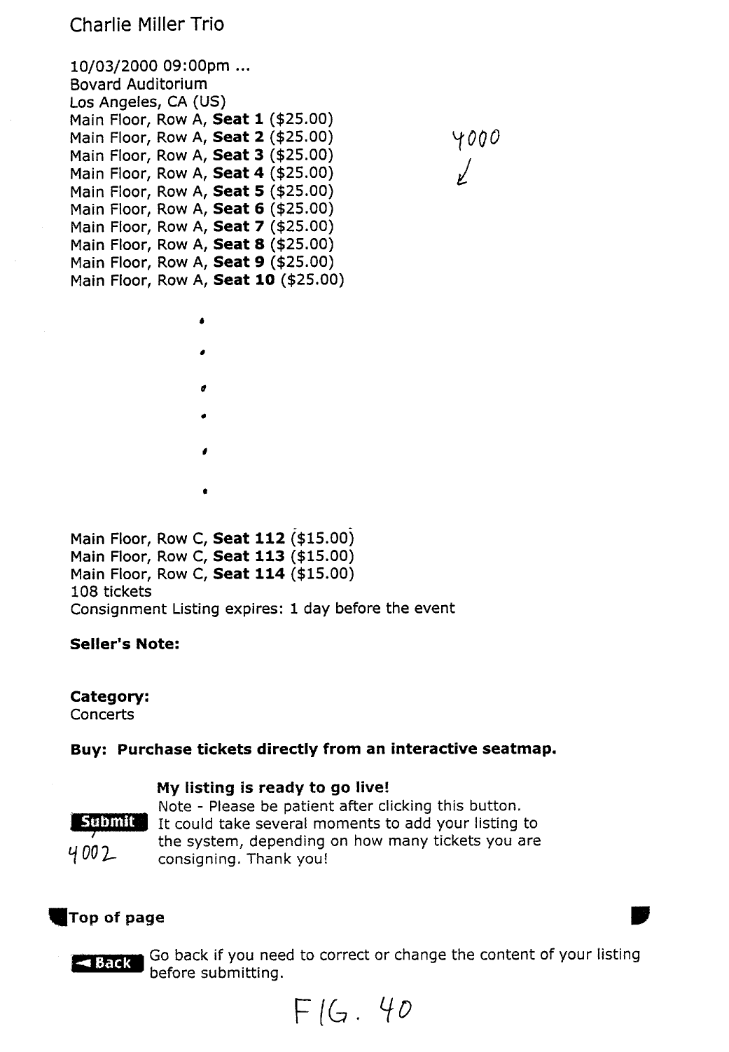

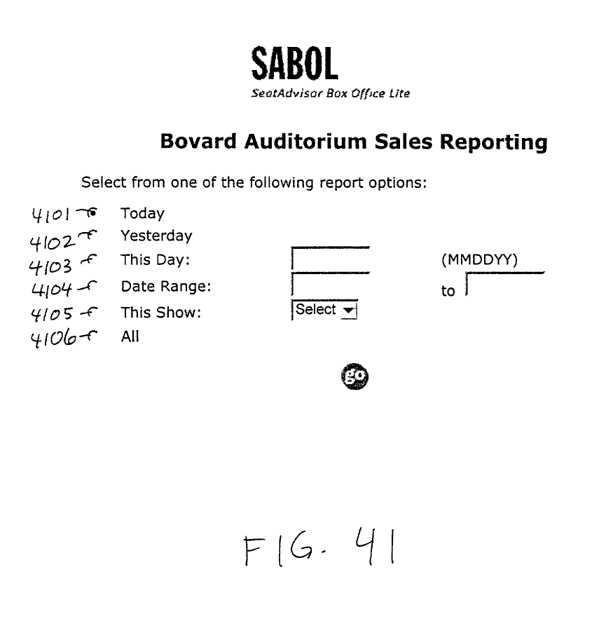

Another confirmation screen 4000 (FIG. 40) may be displayed in state 3226. Once confirmed, the venue operator may submit the seat pricings in state 3228 by selecting a “Submit” button 4002.

According to an embodiment, the venue operator may access ticket sales activity for an event from the venue database 18. FIG. 41 illustrates a display screen 4100 for accessing ticket sales activity. The venue operator may select a report for a particular day, date range, and/or event by selecting one or more selection boxes 4101-4106.

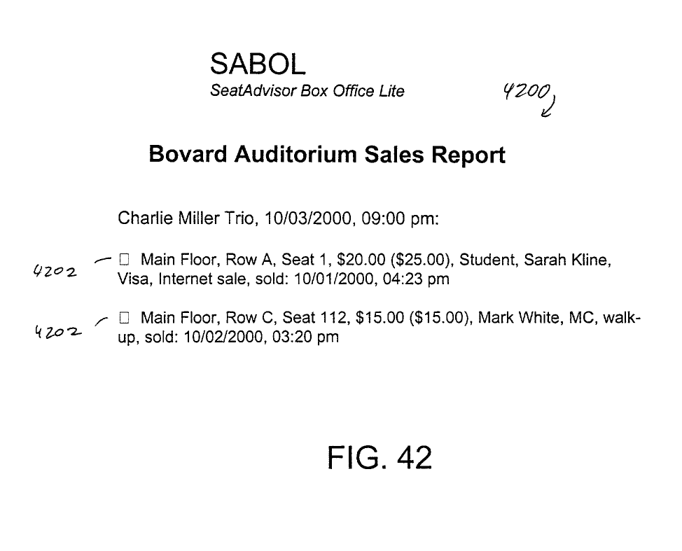

FIG. 42 illustrates an exemplary ticket sales display screen 4200 with a list of ticket sales entries 4202. Each entry for a sold ticket may include, for example, the corresponding seat number, ticket price, date and time sold, purchaser name, name of event, date and time of event, method of sale, channel of sale (e.g., walk-up, phone order, internet), and buyer or discount type (e.g., military, senior, child, student, etc.).

According to an embodiment, the venue operator may run a report based on any of these criteria. This advantageously provides a comprehensive audit trail for tickets sold for the venue.

According to another embodiment, a venue operator may organize templates for a seat map of his venue. The templates may give certain seats or groups of seats a different availability priority. For example, some seats may be reserved for the house, other seats reserved for members of a group (as described above), and other seats designated as general admission, and hence, not for sale. These priority seats maybe displayed as unavailable to other users of the seat selection and ticket purchasing service. For example, seat objects corresponding to unavailable seats may be colored red and/or contain a blinking graphic, such as, for example, a white square.

On the seat map presented to the vendor operator, each group of seats belonging to a particular priority group may share a distinct color. For example, general admission (unassigned) seats may be white, assigned seats available to the public may be light blue, seats available only to particular members of a group may be yellow, and seats reserved by the house may be green. These color assignments are exemplary and may be designated for other types of seats in various embodiments. Further, seats in the same priority group may have different prices, and hence different colors or other means of highlighting.

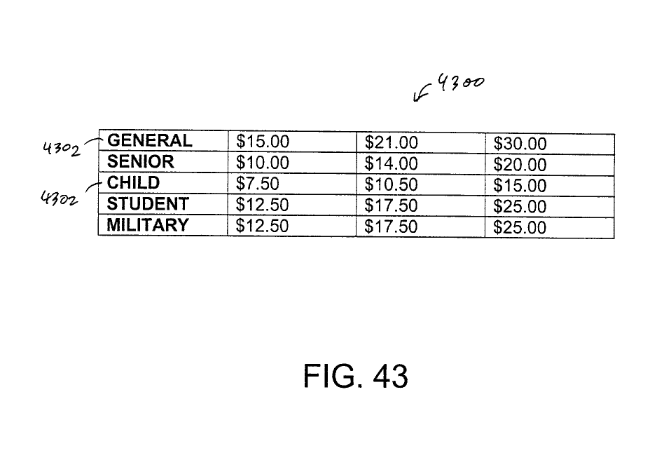

According to another embodiment, seats in a venue may be assigned a tiered pricing structure. Seats assigned a particular price in state 3220 of the seat pricing operation (FIG. 32) may be assigned different prices for different buyer or discount types. FIG. 43 illustrates a table 4300 for entering the different buyer or discount types 4302 and associated tiered pricing. The table may be set up as a spreadsheet and manipulated accordingly in a known manner. The tiered prices may be determined automatically for each type of ticket holder using a spreadsheet formula function.

Accordingly to yet another embodiment, a venue operator may automatically price his venue for a particular show by entering a desired dollar amount, selecting available seats, and other criteria, such as maximum and minimum ticket prices, fixed prices for certain seats, or price ratios between different groups of seats in the house. For example, the venue operator may indicate that the seats in rows C and D should have a price equal to the nearest whole dollar amount above 75% of the ticket price assigned to seats in rows A and B.

The methods and mechanisms described here are not limited to any particular hardware or software configuration, or to any particular communications modality, but rather they may find applicability in any communications or computer network environment.

The techniques described here may be implemented in hardware or software, or a combination of the two. Preferably, the techniques are implemented in computer programs executing one or more programmable computers that each includes a processor, a storage medium readable by the processor (including volatile and non-volatile memory and/or storage elements), and suitable input and output devices. The programmable computers may be either general-purpose computers or special-purpose, embedded systems. In either case, program code is applied to data entered with or received from an input device to perform the functions described and to generate output information. The output information is applied to one or more output devices.

Each program is preferably implemented in a high level procedural or object-oriented programming language to communicate with a computer system. However, the programs can be implemented in assembly or machine language, if desired. In any case, the language may be a compiled or interpreted language.

Each such computer program is preferably stored on a storage medium or device (e.g., CD-ROM, hard disk, magnetic diskette, or memory chip) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

A number of embodiments of the invention have been described. Nevertheless, it will be understood that various modifications may be made without departing from the spirit and scope of the invention. Accordingly, other embodiments are within the scope of the following claims.

What is claimed is:

1. A method for selecting a seat in a venue in a computer network, comprising: selecting a venue;
displaying an interactive seat map corresponding to the venue, said seat map comprising a plurality of pointer-sensitive seat objects representative of seats in a venue, wherein each seat object is linked to at least an entry in a database containing data associated with a corresponding seat;
selecting one of said objects with a pointer device; and
displaying data associated with the selected seat object.

2. The method of claim 1, further comprising selecting an event, wherein a plurality of said plurality of seat objects represent seats available for the event.

3. The method of claim 2, wherein a plurality of said plurality of seat objects represent seats unavailable for the event.

4. The method of claim 3, wherein the seat objects representative of available seats have a first color and the seat objects representative of unavailable seats have a second color.

5. The method of claim 1, wherein the data associated with the selected seat object comprises a photographic image representative of the corresponding seat.

6. The method of claim 1, wherein the data associated with the selected seat object comprises a photographic image representative of a view from the corresponding seat.

7. The method of claim 1, wherein the data associated with the selected seat object comprises a textual review of the corresponding seat.

8. The method of claim 1, wherein the data associated with the selected seat object comprises a textual comment submitted by a user of the corresponding seat.

9. The method of claim 1, wherein the interactive seat map is generated from an image file comprising a plurality of pointer-insensitive seat objects, and wherein each seat object is automatically mapped, numbered, and linked to a corresponding seat entry in a database by a seat mapping operation.

10. The method of claim 1, further comprising:
requesting to reserve the corresponding seat;
prompting a first user at a first user machine for user information;
entering user information;
storing a reservation entry including data indicative of the corresponding seat and the user information in a reservation file; and
making the selected seat object unavailable for reservation requests by other users.

11. The method of claim 10, further comprising:
displaying a corresponding interactive seat map to a second user at a second user machine;
displaying the selected seat object having a first color; and displaying an unselected seat object having a second color, said unselected seat object corresponding to an unreserved seat.

12. The method of claim 10, further comprising:
setting a reservation time period;
storing a time of the reservation request in the reservation entry;
periodically examining the time of the reservation request and a current time; determining if the reservation time period has expired; and
deleting the reservation entry from the reservation file in response to expiration of the reservation time period.

13. The method of claim 1, further comprising:
requesting to purchase a ticket for the corresponding seat;
determining if the corresponding seat is available for purchase; and
in response to the corresponding seat being available for purchase,
prompting a user for payment information;
entering payment information;
processing a sale with the payment information;
storing a sales entry including data indicative of the corresponding seat and the sale in a sales file; and
making the selected seat object unavailable for purchase requests by other users.

14. The method of claim 13, further comprising:
displaying the selected seat object having a first color; and
displaying an unselected seat object having a second color, said unselected seat object corresponding to a seat to which a ticket has not been purchased.

15. A method for pricing a plurality of seats in a venue in a computer network, comprising:
selecting a venue;
entering event information;
displaying an interactive seat map corresponding to the venue, said seat map comprising a plurality of pointer-sensitive seat objects representative of seats in a venue, wherein each seat object is linked to at least an entry in a database containing data associated with a corresponding seat;
selecting a first plurality of said seat objects with a pointer device;
assigning a price to the seat objects in the first plurality of seat objects; and
for each seat object in the first plurality of seat objects, storing data indicative of the corresponding seat, the price, and event information as linked entries in the database.

16. The method of claim 15, further comprising:
selecting a second plurality of seat objects with the pointer device;
assigning a price to the seat objects in the second plurality of seat objects; and
for each seat object in the second plurality of seat objects, storing data indicative of the corresponding seat, the price, and event information as linked entries in the database.

17. The method of claim 15, further comprising:
displaying a list including textual entries corresponding to said first plurality of seat objects, each textual entry comprising an alphanumeric indicator associated with the corresponding seat, the price, and the event information.

18. The method of claim 17, further comprising assigning a plurality of prices to a seat object for an event, each price corresponding to a different one of a plurality of buyer types.

19. An apparatus, including instructions residing on a computer-readable storage medium, for use in a computer system to select a seat in a venue in a networked computer system, the instructions causing the computer to:
select a venue;
display an interactive seat map corresponding to the venue, said seat map comprising a plurality of pointer-sensitive seat objects representative of seats in a venue, wherein each seat object is linked to at least an entry in a database containing data associated with a corresponding seat;
select one of said objects with a pointer device; and
display data associated with the selected seat object.

20. An apparatus, including instructions residing on a computer-readable storage medium, for use in a computer system to price a plurality of seats in a venue in a networked computer system, the instructions causing the computer to:
select a venue;
enter event information;
display an interactive seat map corresponding to the venue, said seat map comprising a plurality of pointer-sensitive seat objects representative of seats in a venue, wherein each seat object is linked to at least an entry in a database containing data associated with a corresponding seat;
select a first plurality of said objects with a pointer device;
assign a price to the seat objects in the first plurality of seat objects; and
for each seat object in the first plurality of seat objects, store data indicative of the corresponding seat, the price, and event information as linked entries in the database.

21. A system for providing information regarding particular seats in a venue in a networked computer system, comprising:
a central site;
a venue database connected to the central site and comprising at least one interactive seat map corresponding to a venue, said seat map comprising a plurality of pointer-sensitive seat objects representative of seats in a venue, wherein each seat object is linked to at least an entry in a database containing data associated with a corresponding seat; and
a user terminal in communication with the central site over the networked computer system.

22. The system of claim 21, further comprising:
a ticketing site to price seats in said at least one seat map for an event; and
a payment processor site to process payments for tickets for the event for a plurality of seats in said at least one seat map.
